(19) United States
(12) Patent Application Publication
(10) Pub. No.: US 2012/0027301 A1
(43) Pub. Date: Feb. 2, 2012

(54) METHOD, DEVICE AND COMPUTER PROGRAM PRODUCT FOR INTEGRATING CODE-BASED AND OPTICAL CHARACTER RECOGNITION TECHNOLOGIES INTO A MOBILE VISUAL SEARCH

(75) Inventors: C. Philipp Schloter, San Francisco, CA (US); Jiang Gao, Sunnyvale, CA (US)

(73) Assignee: NOKIA CORPORATION, Espoo (FI)

(21) Appl. No.: 13/268,223

(22) Filed: Oct. 7, 2011

Related U.S. Application Data
(62) Division of application No. 11/771,556, filed on Jun. 29, 2007.
(60) Provisional application No. 60/913,738, filed on Apr. 24, 2007.

(51) Int. Cl. G06K 9/00

(52) U.S. Cl. 382/181

(57) ABSTRACT

A device for switching between code-based searching, optical character recognition (OCR) searching and visual searching is provided. The device includes a media content input for receiving media content from a camera or other element of the device and transferring this media content to a switch. Additionally, the device includes a meta-information input capable of receiving meta-information from an element of the device and transferring the meta-information to the switch. The switch is able to utilize the received media content and the meta-information to select and/or switch between a visual search algorithm, an OCR algorithm and a code-based algorithm.

### CROSS-REFERENCE TO RELATED APPLICATIONS

The present application is a division of U.S. patent application Ser. No. 11/771,556 filed Jun. 29, 2007 and claims priority to U.S. Provisional Application No. 60/913,738 filed Apr. 24, 2007, the contents of both are incorporated by reference herein in their entirety.

### FIELD OF THE INVENTION

Embodiments of the present invention relate generally to mobile visual search technology and, more particularly, relate to methods, devices, mobile terminals and computer program products for combining a code-based tagging system(s) as well as an optical character recognition (OCR) system(s) with a visual search system(s).

### BACKGROUND OF THE INVENTION

The modern communications era has brought about a tremendous expansion of wireline and wireless networks. Computer networks, television networks, and telephony networks are experiencing an unprecedented technological expansion, fueled by consumer demands, while providing more flexibility and immediacy of information transfer.

Current and future networking technologies continue to facilitate ease of information transfer and convenience to users. One area in which there is a demand to increase ease of information transfer and convenience to users relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, video recorders, cameras, etc, or even from a combination of the mobile terminal and the network device. In this regard, various applications and software have been developed and continue to be developed in order to give the users robust capabilities to perform tasks, communicate, entertain themselves, gather and/or analyze information, etc. in either fixed or mobile environments.

With the wide use of mobile phones with cameras, camera applications are becoming popular for mobile phone users. Mobile applications based on image matching (recognition) are currently emerging and an example of this emergence is mobile visual searching. Currently, there are mobile visual search systems having various scope and applications. For instance, in one type of mobile visual search system such as a Point & Find system, (developed based on technology of PIXTO, recently acquired by Nokia Corp.) a user of a camera phone may point his/her camera phone at objects in surroundings areas of the user to access relevant information associated with the objects that were pointed at via the Internet, which are provided to the camera phone of the user.

Another example of an application that may be used to gather and/or analyze information is a barcode reader. While barcodes have been in use for about half a century, developments related to utilization of barcodes have recently taken drastic leaps with the infusion of new technologies. For example, new technology has enabled the development of barcodes that are able to store product information of increasing detail. Barcodes have been employed to provide links to related sites such as web pages. For instance, barcodes have been employed in tags that are attached with (URLs) to tangible objects (e.g., consider a product having a barcode on the product wherein the barcode is associated with a URL of the product). Additionally, barcode systems have been developed which move beyond typical one dimensional (1D) barcodes to provide multiple types of potentially complex two dimensional (2D) barcodes, ShotCodes, Semacodes, quick response (QR) codes, data matrix codes and the like. Along with changes related to barcode usage and types, new devices have been developed for reading barcodes. Despite the fact that there has been a long history of code-based research and development, integrating code-based searching into a mobile visual search system has not yet been currently explored.

Another example of an application that may be used to gather and/or analyze information is an optical character recognition (OCR) system. OCR systems are capable of translating images of handwritten or typewritten text into machine-editable text, or to translate pictures of characters into a standard encoding scheme representing them (for example ASCII or Unicode). At the same time, optical character recognition (OCR) systems are currently not as well modularized as the existing 1D or 2D visual tagging systems. However, OCR systems have great potential, because text is universally available today and is widespread. In this regard, the need to print and deploy special 1D and 2D barcode tags is diminished. Also, OCR systems can be applied across many different scenarios and applications for example on signs, merchandise labels, products and the like in which 1D and 2D barcodes may not be prevalent or in existence. Additionally, another application in which OCR is becoming useful consists of language translation. Notwithstanding the notion that there has been a long history of OCR research and application development, combining OCR into a mobile visual search system has not currently been explored.

Given the ubiquitous nature of cameras in mobile terminal devices, there exists a need to develop a mobile searching system which combines or integrates OCR into a mobile visual search system which can be used on a mobile phone having a camera so as to enhance a user's experience and enable more efficient transfer of information. Additionally, there also exists a need for future mobile visual search applications to be able to extend mobile search capabilities in a manner that is different from specially designed and modularized code-based visual tagging systems, such as 1D and 2D bar codes, QR codes, Semacode, Shotcode and the like. While there is an expectation that specially designed and modularized visual tagging systems may maintain a certain market share in the future, it can also be foreseen that many applications utilizing such code-based systems alone will not be sufficient in the future. Given that code-based visual tagging systems can typically be modularized, there exists a need to combine such code-based tagging systems with a more general mobile visual search system, which would in turn allow a significant increase in market share for a network operator, cellular service provider or the like as well as providing users with robust capabilities to perform tasks, communicate, entertain themselves, gather and/or analyze information.

While integration of a visual search system with existing 1D and/or 2D tagging systems as well as OCR systems, is of importance for future mobile search businesses, a difficulty arises regarding the manner in which to combine different algorithms and functionalities in a seamless way. That is to say, a difficulty arises regarding the manner in which architecture and system design should be applied in order to enable these 1D and/or 2D tagging systems, OCR systems and visual search systems to operate properly together.

In view of the foregoing, a need exists for innovative designs to solve and address the aforementioned difficulties and to identify a manner in which to combine and integrate OCR, as well as different types of code-based tagging systems into a mobile visual search system which includes design of tagging and retrieval mechanisms.

### BRIEF SUMMARY OF THE INVENTION

Systems, methods, devices and computer program products of the exemplary embodiments of the present invention relate to designs that enable combining a code-based searching system, and an OCR searching system with a visual searching system to form a single unified system. These designs include but are not limited to context-based, detection-based, visualization-based, user-input based, statistical processing based and tag-based designs.

These designs enable the integration of OCR, and code-based functionality (e.g., 1D/2D barcodes) into a single unified visual search system. Exemplary embodiments of the present invention allow users the benefit of a single platform and user interface that combines searching applications namely, OCR searching, code-based searching and object-based visual searching into a single search system. The unified visual search system of the present invention can offer, for example, translation or encyclopaedia functionality when pointing a camera phone at text (as well as other services), while making other information and services available when pointing a camera phone at objects through a typical visual search system (for e.g., a user points a camera phone, such as camera module 36 to the sky to access weather information, restaurant facade for reviews or cars for specification and dealer information). When pointing at a 1D or 2D code, OCR data and the like, the unified search system of the exemplary embodiments of the present invention can, for example, offer comparison shopping information for a product, purchasing capabilities or content links embedded in the code or the OCR data.

In one exemplary embodiment a device and method for integrating visual searching, code-based searching and OCR searching are provided. The device and method includes receiving media content, analyzing data associated with media content and selecting a first algorithm among a plurality of algorithms. The device and method further include executing the first algorithm and performing one or more searches and receiving one or more candidates corresponding to the media content.

In another exemplary embodiment, a device and method for integrating visual searching, code-based searching and OCR searching are provided. The device and method include receiving media content and meta-information, receiving one or more search algorithms, executing the one or more search algorithms and performing one or more searches on the media content and collecting corresponding results. The device and method further include receiving the results and prioritizing the results based on one or more factors.

In another exemplary embodiment, a device and method for integrating visual searching, code-based searching and OCR searching are provided. The device and method includes receiving media content and meta-information, receiving a plurality of search algorithms, executing a first search algorithm among the plurality of search algorithms and detecting a first type of one or more tags associated with the media content. The device and method further includes determining whether a second and a third type of one or more tags are associated with the media content, executing a second search algorithm among the plurality of search algorithms and detecting data associated with the second and the third type of one or more tags and receiving one or more candidates. The device and method further includes inserting respective ones of the one or more candidates comprising data corresponding to the second and third types of one or more tags into a respective one of the one or more candidates corresponding the first type of one or more tags, wherein the first, second and third types are different.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a schematic block diagram of a mobile visual search system with 1D/2D image tagging or an Optical Character Recognition (OCR) system by using location information according to an exemplary embodiment of the present invention;

FIG. 4 is a schematic block diagram of a mobile visual search system that is integrated with 1D/2D image tagging or an OCR system by using contextual information and rules according to an exemplary embodiment of the present invention;

FIG. 5 is a schematic block diagram of an exemplary embodiment of a search module for integrating visual searching, code-based searching and OCR searching utilizing location information;

FIG. 6 is a flowchart for a method of operation of a search module which integrates visual searching, code-based searching and OCR searching utilizing location information;

FIG. 7 is a schematic block diagram of an alternative exemplary embodiment of a search module for integrating visual searching, with code-based searching and OCR searching utilizing rules and meta-information;

FIG. 8 is a flowchart for a method of operation of a search module which integrates visual searching, with code-based searching and OCR searching utilizing rules and meta-information;

FIG. 9 is a schematic block diagram of an alternative exemplary embodiment of a search module for integrating visual searching, OCR searching and code-based searching utilizing image detection;

FIG. 10 is a flowchart for a method of operation of a search module which integrates visual searching, OCR searching and code-based searching utilizing image detection;

FIG. 11 is a schematic block diagram of alternative exemplary embodiment of a search module for integrating visual searching, code-based searching and OCR searching utilizing a visualization engine;

FIG. 12 is a flowchart for a method of operation of a search module which integrates visual searching, code-based searching and OCR searching utilizing a visualization engine;

FIG. 13 is a schematic block diagram of an alternative exemplary embodiment of a search module for integrating visual searching, code-based searching and OCR searching utilizing a user's input;

FIG. 14 is a flowchart for a method of operation of a search module for integrating visual searching, code-based searching and OCR searching utilizing a user's input;

FIG. 15 is a schematic block diagram of an alternative exemplary embodiment of a search module integrating visual searching, code-based searching and OCR searching utilizing statistical processing;

FIG. 16 is a flowchart for a method of operation of a search module integrating visual searching, code-based searching and OCR searching utilizing statistical processing;

FIG. 17 is a schematic block diagram of an alternative exemplary embodiment of a search module for embedding code-based tags and/or OCR tags into visual search results; and

FIG. 18 is a flowchart for a method of operation of a search module for embedding code-based tags and/or OCR tags into visual search results.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

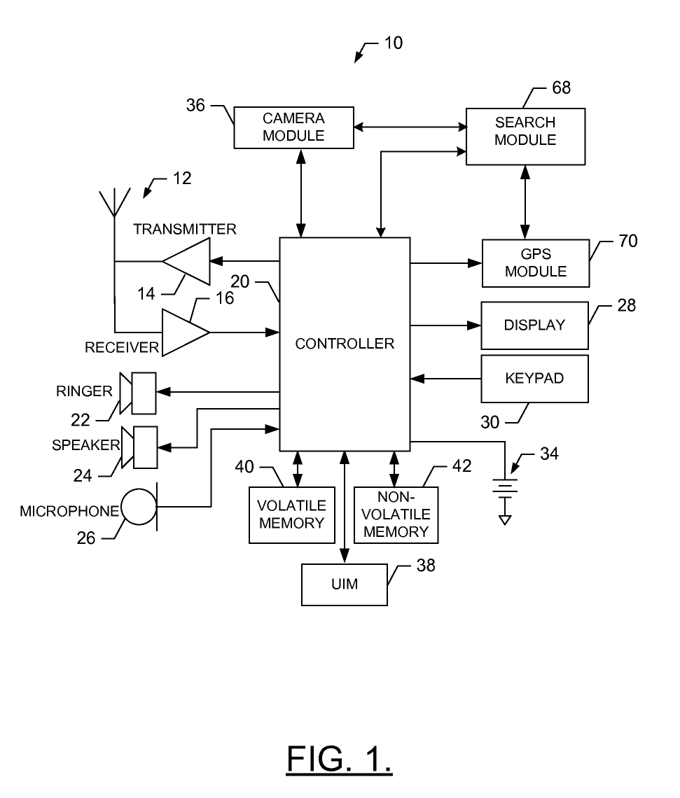

FIG. 1 illustrates a block diagram of a mobile terminal 10 that would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile televisions, laptop computers and other types of voice and text communications systems, can readily employ the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a camera module 36 in communication with the controller 20. The camera module 36 may be any means for capturing an image or a video clip or video stream for storage, display or transmission. For example, the camera module 36 may include a digital camera capable of forming a digital image file from an object in view, a captured image or a video stream from recorded video data. The camera module 36 may be able to capture an image, read or detect 1D and 2D bar codes, QR codes, Semacode, Shotcode, data matrix codes, as well as other code-based data, OCR data and the like. As such, the camera module 36 includes all hardware, such as a lens, sensor, scanner or other optical device, and software necessary for creating a digital image file from a captured image or a video stream from recorded video data, as well as reading code-based data, OCR data and the like. Alternatively, the camera module 36 may include only the hardware needed to view an image, or video stream while a memory device of the mobile terminal 10 stores instructions for execution by the controller 20 in the form of software necessary to create a digital image file from a captured image or a video stream from recorded video data. In an exemplary embodiment, the camera module 36 may further include a processing element such as a co-processor which assists the controller 20 in processing image data, a video stream, or code-based data as well as OCR data and an encoder and/or decoder for compressing and/or decompressing image data, a video stream, code-based data, OCR data and the like. The encoder and/or decoder may encode and/or decode according to a JPEG standard format, and the like. Additionally, or alternatively, the camera module 36 may include one or more views such as, for example, a first person camera view and a third person map view.

The mobile terminal 10 may further include a GPS module 70 in communication with the controller 20. The GPS module 70 may be any means for locating the position of the mobile terminal 10. Additionally, the GPS module 70 may be any means for locating the position of point-of-interests (POIs), in images captured or read by the camera module 36, such as for example, shops, bookstores, restaurants, coffee shops, department stores, products, businesses and the like which may have 1D, 2D bar codes, QR codes, Semacodes, Shotcodes, data matrix codes, (or other suitable code-based data) ORC data and the like, attached to i.e., tagged to these POIs. As such, points-of-interest as used herein may include any entity of interest to a user, such as products and other objects and the like. The GPS module 70 may include all hardware for locating the position of a mobile terminal or a POI in an image. Alternatively or additionally, the GPS module 70 may utilize a memory device of the mobile terminal 10 to store instructions for execution by the controller 20 in the form of software necessary to determine the position of the mobile terminal or an image of a POI. Additionally, the GPS module 70 is capable of utilizing the controller 20 to transmit/receive, via the transmitter 14/receiver 16, locational information such as the position of the mobile terminal 10, the position of one or more POIs, and the position of one or more code-based tags, as well OCR data tags, to a server, such as the visual search server 54 and the visual search database 51, described more fully below.

The mobile terminal also includes a search module such as search module 68, 78, 88, 98, 108, 118 and 128. The search module may include any means of hardware and/or software, being executed by controller 20, (or by a co-processor internal to the search module (not shown)) capable of receiving data associated with points-of-interest, (i.e., any physical entity of interest to a user) code-based data, OCR data and the like when the camera module of the mobile terminal 10 is pointed at POIs, code-based data, OCR data and the like or when the POIs, code-based data and OCR data and the like are in the line of sight of the camera module 36 or when the POIs, code-based data, OCR data and the like are captured in an image by the camera module. The search module is capable of interacting with a search server 54 and it is responsible for controlling the functions of the camera module 36 such as camera module image input, tracking or sensing image motion, communication with the search server for obtaining relevant information associated with the POIs, the code-based data and the OCR data and the like as well as the necessary user interface and mechanisms for displaying, via display 28, the appropriate results to a user of the mobile terminal 10. In an exemplary alternative embodiment the search module 68, 78, 88, 98, 108, 118 and 128 may be internal to the camera module 36.

The search module 68 is also capable of enabling a user of the mobile terminal 10 to select from one or more actions in a list of several actions (for example in a menu or sub-menu) that are relevant to a respective POI, code-based data and/or OCR data and the like. For example, one of the actions may include but is not limited to searching for other similar POIs (i.e., candidates) within a geographic area. For example, if a user points the camera module at a car manufactured by HONDA™, (in this e.g. the POI) the mobile terminal may display a list or a menu of candidates relating to other car manufactures for example, FORD™, CHEVROLET™, etc. As another example, if a user of the mobile terminal points the camera module at a 1D or 2D bar code, relating to a product for example, the mobile terminal may display a list of other similar products or URLs containing information relating to these similar products. Information relating to these similar POIs may be stored in a user profile in a memory.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

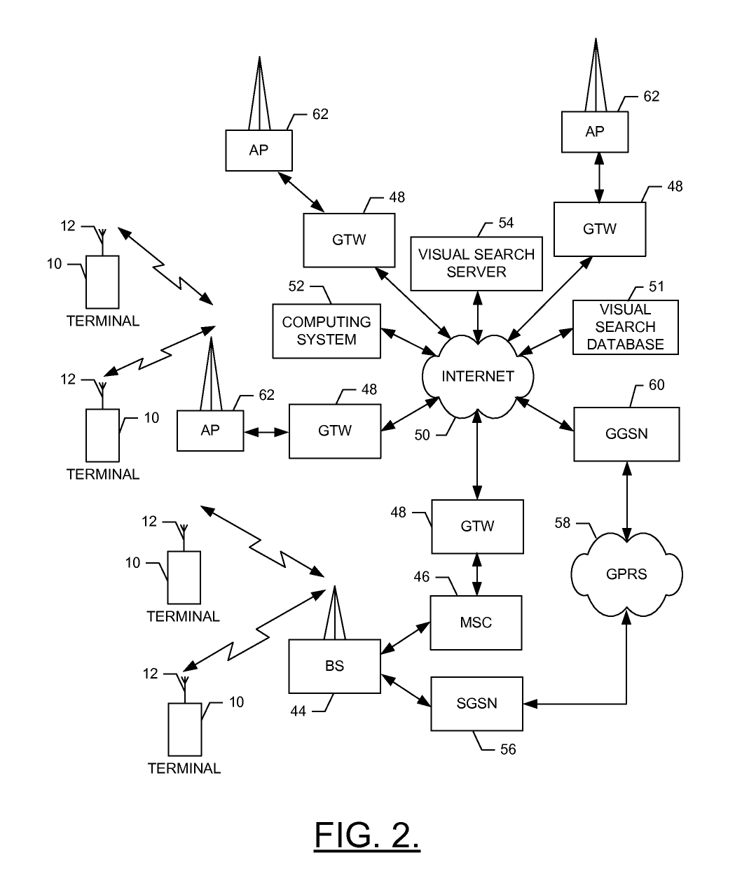

Referring now to FIG. 2, an illustration of one type of system that would benefit from the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (one shown in FIG. 2), visual search server 54 (one shown in FIG. 2), visual search database 51, or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or visual map server 54 may be coupled to the mobile terminal 10 via the Internet 50, SGSN 56 and GGSN 60. In this regard, devices such as the computing system 52 and/or visual map server 54 may communicate with the mobile terminal 10 across the SGSN 56, GPRS core network 58 and the GGSN 60. By directly or indirectly connecting mobile terminals 10 and the other devices (e.g., computing system 52, visual map server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), Wibree, infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the visual search server 54, and/or any of a number of other devices, to the Internet 50, the mobile terminals 10 can communicate with one another, the computing system, 52 and/or the visual search server 54 as well as the visual search database 51, etc., to thereby carry out various functions of the mobile terminals 10, such as to transmit data, content or the like to, and/or receive content, data or the like from, the computing system 52. For example, the visual search server handles requests from the search module 68 and interacts with the visual search database 51 for storing and retrieving visual search information. The visual search server 54 may provide map data and the like, by way of map server 96, relating to a geographical area, location or position of one or more or mobile terminals 10, one or more POIs or code-based data, OCR data and the like. Additionally, the visual search server 54, may provide various forms of data relating to target objects such as POIs to the search module 68 of the mobile terminal. Additionally, the visual search server 54 may provide information relating to code-based data, OCR data and the like to the search module 68. For instance, if the visual search server receives an indication from the search module 68 of the mobile terminal that the camera module detected, read, scanned or captured an image of a 1D, 2D bar code, Semacode, Shotcode, QR code, data matrix code (collectively referred to herein as code-based data) and/or OCR data, for e.g., text data, the visual search server 54 may compare the received code-based data and/or OCR data with associated data stored in the point-of-interest (POI) database 74 and provide, for example, comparison shopping information for a given product(s), purchasing capabilities and/or content links, such as URLs or web pages to the search module to be displayed via display 28. That is to say, that the code-based data and the OCR data in which the camera module detects, reads, scans or captures an image of contains information relating to the comparison shopping information, purchasing capabilities and/or content links and the like. When the mobile terminal receives the content links (e.g. URL), it may utilize its Web browser to display the corresponding web page via display 28. Additionally, the visual search server 54 may compare the received OCR data, such as for example, text on a street sign detected by the camera module 36 with associated data such as map data and/or directions, via map server 96, in a geographic area of the mobile terminal and/or in a geographic area of the street sign. It should be pointed out that the above are merely examples of data that may be associated with the code-based data and/or OCR data and in this regard any suitable data may be associated with the code-based data and/or the OCR data described herein.

Additionally, the visual search server 54 may perform comparisons with images or video clips (or any suitable media content including but not limited to text data, audio data, graphic animations, code-based data, OCR data, pictures, photographs and the like) captured or obtained by the camera module 36 and determine whether these images or video clips or information related to these images or video clips are stored in the visual search server 54. Furthermore, the visual search server 54 may store, by way of POI database server 74, various types of information relating to one or more target objects, such as POIs that may be associated with one or more images or video clips (or other media content) which are captured or detected by the camera module 36. The information relating to the one or more POIs may be linked to one or more tags, such as for example, a tag on a physical object that is captured, detected, scanned or read by the camera module 36. The information relating to the one or more POIs may be transmitted to a mobile terminal 10 for display. Moreover, the visual search database 51 may store relevant visual search information including but not limited to media content which includes but is not limited to text data, audio data, graphical animations, pictures, photographs, video clips, images and their associated meta-information such as for example, web links, geo-location data (as referred to herein geo-location data includes but is not limited to geographical identification metadata to various media such as websites and the like and this data may also consist of latitude and longitude coordinates, altitude data and place names), contextual information and the like for quick and efficient retrieval. Furthermore, the visual search database 51 may store data regarding the geographic location of one or more POIs and may store data pertaining to various points-of-interest including but not limited to location of a POI, product information relative to a POI, and the like. The visual search database 51 may also store code-based data, OCR data and the like and data associated with the code-based data, OCR data including but not limited to product information, price, map data, directions, web links, etc. The visual search server 54 may transmit and receive information from the visual search database 51 and communicate with the mobile terminal 10 via the Internet 50. Likewise, the visual search database 51 may communicate with the visual search server 54 and alternatively, or additionally, may communicate with the mobile terminal 10 directly via a WLAN, Bluetooth, Wibree or the like transmission or via the Internet 50. The visual search input control/interface 98 serves as an interface for users, such as for example, business owners, product manufacturers, company's and the like to insert their data into the visual search database 51. The mechanism for controlling the manner in which the data is inserted into the visual search database can be flexible, for example, the new inserted data can be inserted based on location, image, time, or the like. Users may insert 1D bar codes, 2D bar codes, QR codes, Semacode, Shotcode, (i.e., code-based data) or OCR data relating to one or more objects, POIs, products or like (as well as additional information) into the visual search database 51, via the visual search input control/interface 98. In an exemplary non-limiting embodiment, the visual search input control/interface 98 may be located external to the visual search database. As used herein, the terms “images,” “video clips,” “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing system 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

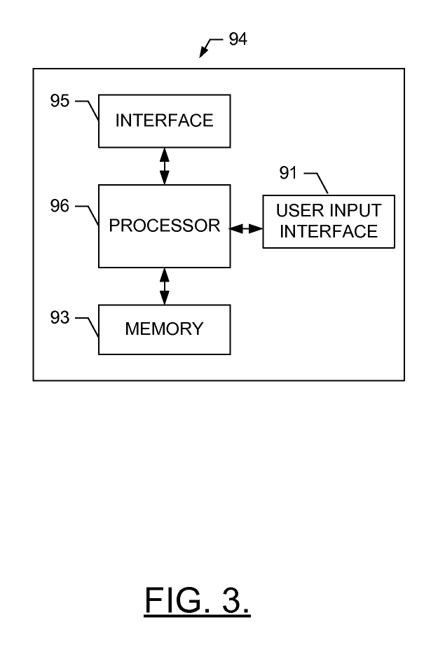

Referring to FIG. 3, a block diagram of server 94 is shown. As shown in FIG. 3, server 94 (also referred to herein as visual search server 54, POI database 74, visual search input control/interface 98, visual search database 51 and the visual search server 54) is capable of allowing a product manufacturer, product advertiser, business owner, service provider, network operator, or the like to input relevant information (via the interface 95) relating to a target object for example a POI, as well as information associated with code-based data (such as for example web links or product information) and/or information associated with OCR data (such as for example merchandise labels, web pages, web links, yellow pages information, images, videos, contact information, address information, positional information such as waypoints of a building, locational information, map data and any other suitable data for storage in a memory 93. The server 94 generally includes a processor 96, controller or the like connected to the memory 93, as well as an interface 95 and a user input interface 91. The processor can also be connected to at least one interface 95 or other means for transmitting and/or receiving data, content or the like. The memory can comprise volatile and/or non-volatile memory, and is capable of storing content relating to one or more POIs, code-based data, as well as OCR data as noted above. The memory 93 may also store software applications, instructions or the like for the processor to perform steps associated with operation of the server in accordance with embodiments of the present invention. In this regard, the memory may contain software instructions (that are executed by the processor) for storing, uploading/downloading POI data, code-based data, OCR data, as well as data associated with POI data, code-based data, OCR data and the like and for transmitting/receiving the POI, code-based, OCR data and their respective associated data, to/from mobile terminal 10 and to/from the visual search database as well as the visual search server. The user input interface 91 can comprise any number of devices allowing a user to input data, select various forms of data and navigate menus or sub-menu's or the like. In this regard, the user input interface includes but is not limited to a joystick(s), keypad, a button(s), a soft key(s) or other input device(s).

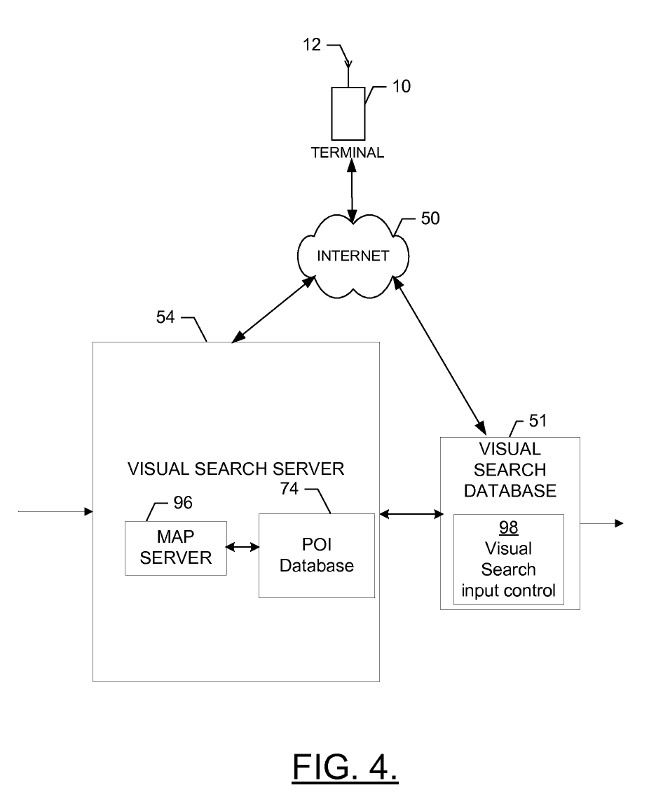

Referring now to FIG. 4, a system for integrating code-based data, OCR data and visual search data is provided. The system includes a visual search server 54 in communication with a mobile terminal 10 as well as a visual search database 51. The visual search server 54 may be any device or means such as hardware or software capable of storing map data, location, or positional information, in the map server 96, POI data, in the POI database 74, as well as images or video clips or any other data (such as for example other types of media content). Additionally, as noted above, the visual search server 54 and the POI database 74 may also store code-based data, OCR data and the like and is also capable of storing data associated with the code-based data and the OCR data. Moreover, the visual search server 54 may include a processor 96 for carrying out or executing functions including execution of software instructions. (See e.g. FIG. 3) The media content includes but is not limited to images, video clips, audio data, text data, graphical animations, photographs, pictures, code-based data, OCR data and the like may correspond to a user profile that is stored in memory 93 of the visual search server on behalf of a user of the mobile terminal 10. Objects that the camera module 36 captures an image of, or detects, reads, scans, which is provided to the visual search server may be linked to positional or geographical information pertaining to the location of the object(s) by the map server 96. Similarly, the visual search database 51 may be any device or means such as hardware or software capable of storing information pertaining to points-of-interest, code-based data, OCR data and the like. The visual search database 51 may include a processor 96 for carrying out or executing functions or software instructions. (See e.g. FIG. 3) The media content may correspond to a user profile that is stored in memory 93 on behalf of a user of the mobile terminal 10. The media content may be loaded into the visual search database 51 via a visual search input control/interface 98 and stored in the visual search database on behalf of a user such as a business owner, product manufacturer, advertiser, and company or on behalf of any other suitable entity. Additionally, various forms of information may be associated with the POI information such as position, location or geographic data relating to a POI, as well as, for example, product information including but not limited to identification of the product, price, quantity, web links, purchasing capabilities, comparison shopping information and the like. As noted above, the visual search advertiser input control/interface 98 may be included in the visual search database 51 or may be located external to the visual search database 51.

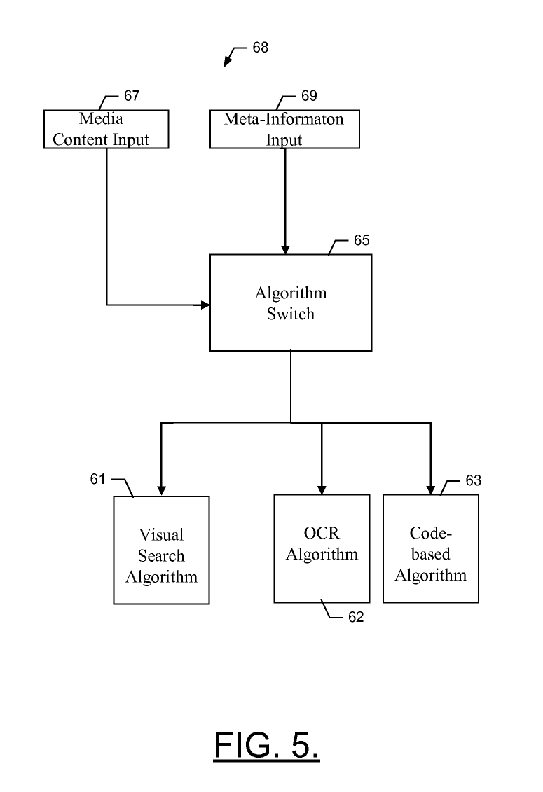

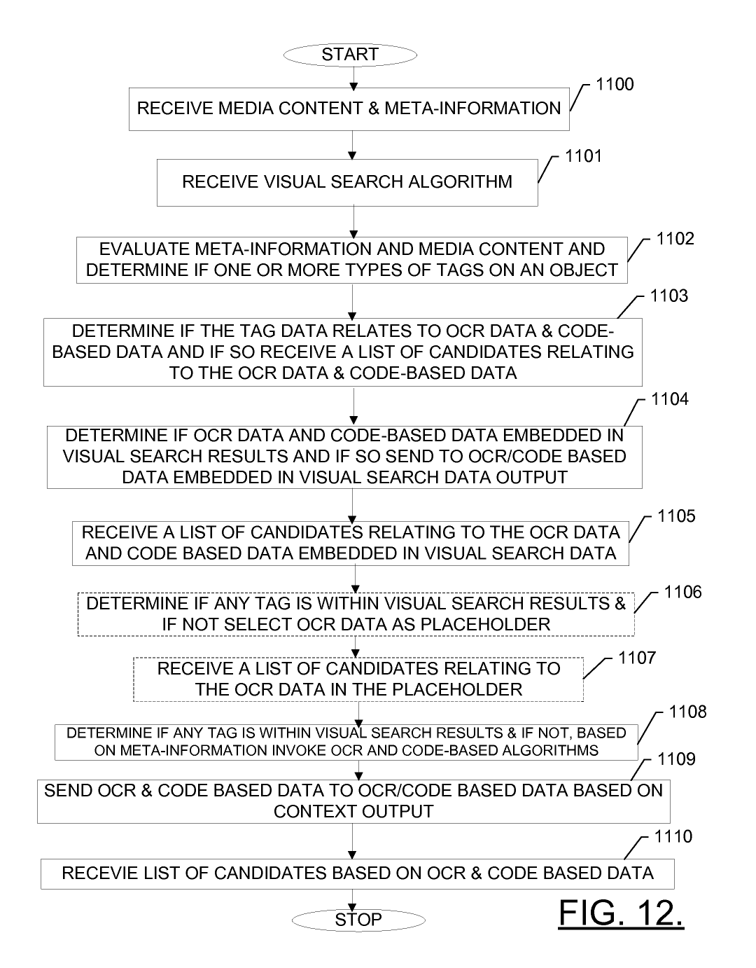

Exemplary embodiments of the invention will now be described with reference to FIGS. 5-18 in which certain elements of a search module for integrating mobile visual search data with code-based data such as for example 1D or 2D image tags/barcodes and/or OCR data are provided. Some of the elements of the search module of FIGS. 5, 7, 9, 11, 13, 15 and 17 may be employed, for example, on the mobile terminal 10 of FIG. 1 and/or the visual search server 54 of FIG. 4. However, it should be noted that the search modules of FIGS. 5, 7, 9, 11, 13, 15 and 17 may also be employed on a variety of other devices, both mobile and fixed, and therefore, the present invention should not be limited to application on devices such as the mobile terminal 10 of FIG. 1 or the visual search server of FIG. 4 although an exemplary embodiment of the invention will be described in greater detail below in the context of application in a mobile terminal. Such description below is given by way of example and not of limitation. For example, the search modules of FIGS. 5, 7, 9, 11, 13, 15 and 17 may be employed on a camera, a video recorder, etc. Furthermore, the search modules of FIGS. 5, 7, 9, 11, 13, 15 and 17 may be employed on a device, component, element or module of the mobile terminal 10. It should also be noted that while FIGS. 5, 7, 9, 11, 13, 15 and 17 illustrate examples of a configuration of the search modules, numerous other configurations may also be used to implement the present invention.

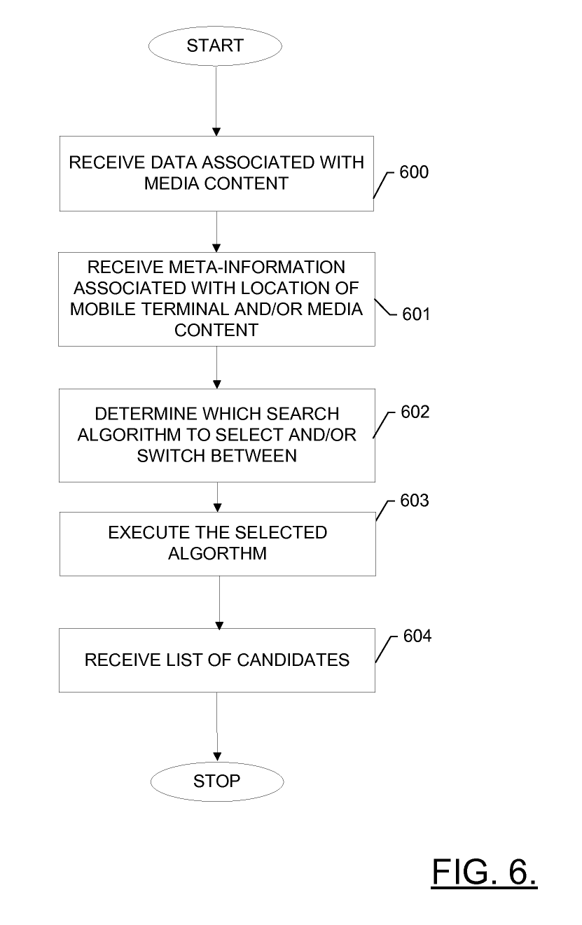

Referring now to FIGS. 5 and 6, an exemplary embodiment, and a flowchart for operation of a search module which integrates visual searching technology, with code-based searching technology and OCR searching technology by utilizing location information is illustrated. The search module 68 may be any device or means including hardware and/or software capable of switching between visual searching, code-based searching and OCR searching based on location. For example, the controller 20 may execute software instructions to carry out the functions of the search module 68 or the search module 68 may have an internal co-processor, which executes software instructions for switching between visual searching, code-based searching and OCR searching based on location. The media content input 67 may be any device or means of hardware and/or software capable (executed by a processor such as controller 20) of receiving media content from the camera module 36 or any other element of the mobile terminal.

When the camera module 36 of the mobile terminal 10 is pointed at media content (including but not limited to an image(s), video clip(s)/video data, graphical animation, etc.) such as an object which is detected, read, scanned or the camera module 36 captures an image of the object, i.e., the media content, (Step 600) the search module 68 can determine the location of the object and/or utilize the location of the mobile terminal 10 provided by GPS module 70 (Step 601) (or by using techniques such as cell identification, triangulation or any other suitable mechanism for identifying the location of an object), via the meta-information input 69, to determine whether to select and/or switch between and subsequently execute a visual search algorithm 61, an OCR algorithm 62 or a code-based algorithm 63. (Step 602 & Step 603) The visual search algorithm 61, the OCR algorithm 62 or the code-based algorithm may be implemented and embodied by any means of hardware and/or software capable of performing visual searching, code-based searching and OCR searching, respectively. The algorithm switch 65 may be any means or hardware and/or software, and may defined with one or more rules, for determining if a given location is assigned to the visual search algorithm 61, the OCR algorithm 62, or the code-based algorithm 63. For example, if the algorithm switch 65 determines that a location, received via meta-information input 69, of the media content, or alternatively the location of the mobile terminal 10 is within a certain region, for example within outdoor Oakland, Calif., the algorithm switch may determine based on this location (i.e., outdoor Oakland, Calif.) that visual searching capabilities are assigned to this location, and enables the visual search algorithm 61 of the search module. In this regard, the search module 68 is capable of searching information associated with an image that is pointed at or captured by the camera module. For example, if the camera module 36 captured an image or was pointed at a product such as a stereo made by SONY™, this image could be provided to the visual search server 51, via media content input 67, which may identify information associated with the image (i.e., candidates, which may be provided in a list) of the stereo, such as for example links to SONY's™ website displaying the stereo, price, product specification features, etc. that are sent to the search module of the mobile terminal for display on display 28. (Step 604) It should be pointed out that any data associated with the media content (e.g., image data, video data) or POI pointed at and/or captured by the camera module 36 that is stored in the visual search server 51 may be provided to the search module 68 of the mobile terminal and displayed on the display 28 when the visual search algorithm 61 is invoked. The information provided to the search module 68 may also be retrieved by the visual search server 68 via the POI database 74.

If the algorithm switch 65 determines that the location of the media content 67 and/or the mobile terminal corresponds to another geographic area, for example, Los Angeles, Calif., the algorithm switch could determine that the mobile terminal is to acquire, for example, code-based searching provided by the code-based algorithm 63 in stores (e.g., bookstores, grocery stores, department stores and the like) located within Los Angeles, Calif. for example. In this regard, the search module 68 is able to detect, read or scan a 1D and/or 2D tag(s) such as a barcode(s), Semacode, Shotcode, QR codes, data matrix codes and any other suitable code-based data when the camera module 36 is pointed at any of these code-based data. When the camera module 36 points at the code-based data such as a 1D and/or 2D barcode and the 1D and/or 2D barcode is detected, read, or scanned by the search module 68, data associated with, tagged, or embedded in the barcode such as a URL for a product, price, comparison shopping information and the like can be provided to the visual search server 54 which may decode and retrieve this information from memory 93 and/or POI database 74 and sends this information to the search module 68 of the mobile terminal for display on display 28. It should be pointed out that any information associated in the tag or barcode of the code-based data could be provided to the visual search server, retrieved by the visual search server and provided to the search module 68 for display on display 28.

As another example, the algorithm switch 65 could also determine that the location of the media content 67 and/or the mobile terminal is within a particular area of a geographic area or region for example within a square, sphere, rectangular, or other proximity-based shape within a radius of a given geographic region. For example, the algorithm switch 65 could determine that when the location of the mobile terminal and/or media content is within downtown Los Angeles (as opposed to the outskirts and suburbs) the mobile terminal may get, for example, the OCR searching capabilities provided by the OCR algorithm 62, and when the location of the media content and/or the mobile terminal is determined to be located in the outskirts of downtown Los Angeles or its suburban area the mobile terminal may obtain, for example, code-based searching provided by the code-based algorithm 63. For example, when the mobile terminal is within, for example, stores or other physical entities having code-based data (e.g. bookstores, grocery stores or department stores and the like) that are located in the outskirts of downtown Los Angeles, the mobile terminal 10 may obtain the code-based searching capabilities provided by the OCR algorithm 62. On the other hand, when the mobile terminal or media content is within Los Angeles, (as opposed to the outskirts and suburbs) for example, and when the camera module is pointed at text data on an object such as, for example, a street sign, the search module detects, reads or scans the text data on the street sign (or on any target object) using OCR and this OCR information is provided to the visual search server 54 which may retrieve associated data such as for example map data and/or directions (via map server 96) near the street sign.

Additionally, the algorithm switch 65 could determine that when the location of the mobile terminal and/or media content is in a country other than the user's home country, (e.g., France) the mobile terminal may get, for example, the OCR searching capabilities provided by the OCR algorithm. In this regard, OCR searches of text data on objects (e.g., street signs in France with text written in French) can be translated into one or more languages such as English, for example (or a language predominantly used in the user's home country (e.g., English when the user's home country is the United States)). This OCR information (e.g., text data written in French) is provided to the visual search server 54 which may retrieve associated data such as for example a translation of the French text data into English. In this regard, the OCR algorithm 62 may be beneficial to tourists traveling abroad. It should be pointed out that the above situation is representative of an example and that when the OCR algorithm 62 is invoked any suitable data corresponding to the OCR data that is detected, read, or scanned by the search module may be provided to the visual search server 54, retrieved and sent by the visual search server 54 to the search module for display on display 28.

Additionally, the algorithm switch 65 can also assign a default recognition algorithm/engine that is to be used for locations identified to be outside of defined regions i.e., regions that are not specified in the rules of the algorithm switch. The regions can be defined within a memory (not shown) of the search module. For example, when the algorithm switch receives an indication, via meta-information input 69 that the location of the media content 67 and/or the mobile terminal is outside of California, (i.e., a location outside of a defined region) the algorithm switch 65 may determine that the mobile terminal 10 obtains, for example, visual searching capabilities, via visual search algorithm 61. In other words, when the algorithm switch determines that the location of the mobile terminal 10 or the media content 67 is outside of the defined region, the algorithm switch may select a recognition engine, such as the visual search algorithm 61, or the OCR algorithm 62, or the code-based algorithm 63 as a default searching application to be invoked by the mobile terminal.

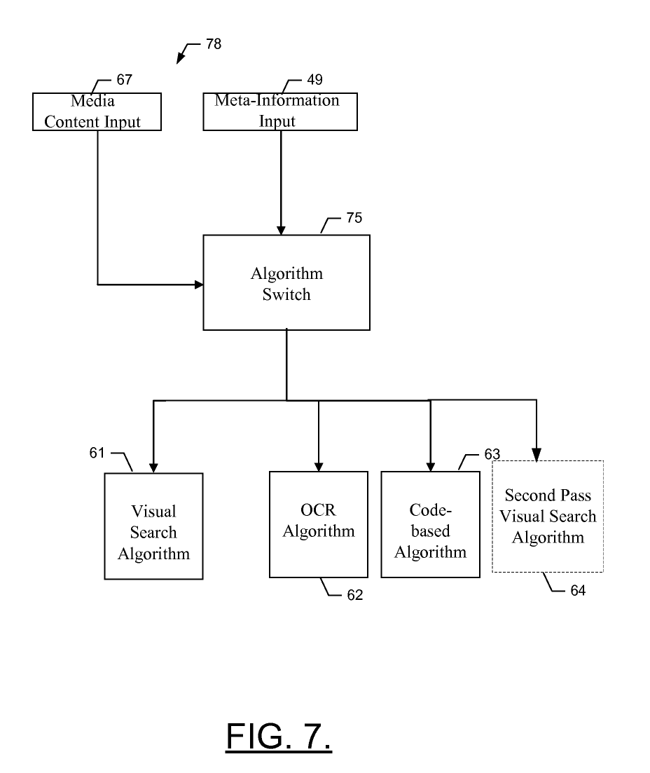

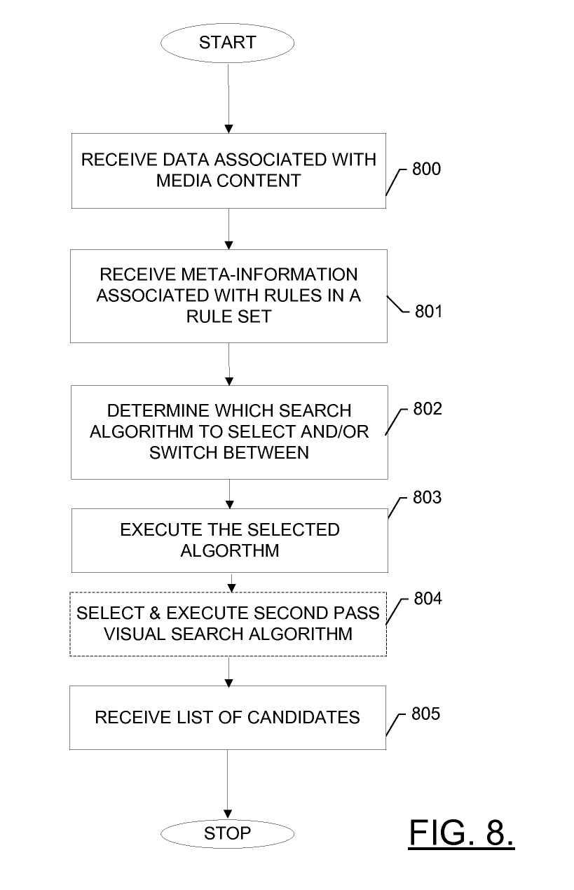

Referring now to FIGS. 7 and 8, an exemplary embodiment, and a flowchart for operation of a search module for integrating visual searching (for example mobile visual searching) with code-based searching, and OCR searching utilizing rules and meta-information is provided. In the search module 78, the algorithm switch 75 may receive or be provided with media content, from the camera module or any other suitable device of the mobile terminal 10, via media content input 67. (Step 800) Additionally, in the search module 78, the algorithm switch 65 may be defined by a set of rules, which determine which recognition engine i.e., visual search algorithm 61, OCR algorithm 62 and code-based algorithm 63 will be invoked or enabled. In this regard, a set of rules may be applied by the algorithm switch 75 that takes as input meta-information. These rules in the rule set may be input, via meta-information input 49, into the algorithm switch 75 by an operator, such as a network operator or may be input by the user using the keypad 30 of the mobile terminal. (Step 801) Further, the rules may, but need not, take the form of logical functions or software instructions. As noted above, the rules that are defined in the algorithm switch 75 may be defined by meta-information input by the operator or the user of the mobile terminal and examples of meta-information include but are not limited to geo-location, time of day, season, weather, and characteristics of the mobile terminal user, product segments or any other suitable data associated with real-world attributes or features.

Based on the meta-information in the set of rules, the algorithm switch/rule engine 75 may calculate an output that determines which algorithm among the visual search algorithm 61, the OCR algorithm 62 and the code-based algorithm 63 should be used by the search module. (Step 802) Based on the output of the algorithm switch 75, the corresponding algorithm is executed (Step 803) and a list of candidates is created relating to the media content that was pointed at or captured by the camera module 36. For example, if the meta-information in the set of rules consists of, for example, weather information, the algorithm switch 65 may determine that the mobile visual searching algorithm 61 should be applied. As such, when the user of the mobile terminal points the camera at the sky, for example, information associated with the information of the sky (e.g., an image of the sky) is provided to a server such as visual search server 54 which determines if there is data matching the information associated with the sky, and if so the visual search server 54 provides the search module 68 with a list of candidates to be displayed on display 28. (Step 805; See discussion of optional Step 804 below) These candidates could include weather relating information for the surrounding area of the user, such as, for example, a URL to a website of THE WEATHER CHANNEL™ or URL to a website of ACCUWEATHER™. The meta-information in the set of rules may be linked to at least one of the visual search algorithm 61, the OCR algorithm 62, and the code based algorithm. As another example, if the meta-information consists of geo-location data in the set of rules, the operator or the user of the mobile terminal may link this geo-location data to the code-based search algorithm. As such, when the location of mobile terminal and/or media content 67 is determined by the GPS module 70 for example, and is provided to the algorithm switch 75, (See FIG. 1) the algorithm switch 75 may determine to apply one of the visual search algorithm 61, the OCR algorithm 62 or the code-based algorithm 63. In this example suppose that the algorithm switch 75 applies the code-based algorithm 63. As such, if the location information identifies a supermarket for example, the rules may specify that when the geo-location data relates to a supermarket, the algorithm switch may enable the code-based algorithm 65 which allows the camera module 36 of the mobile terminal 10 to detect, read or scan 1D and 2D barcodes and the like and retrieve associated data such as price information, URLs, comparison shopping information and other suitable information from the visual search server 54.

If the meta-information in the rules set consists of a product segment, for example, this meta-information could be linked to the OCR algorithm 62 (or the visual search algorithm or the code-based algorithm). In this regard, when a user points the camera module at a product such as a car (or any other product of relevance to the user (e.g., POI), the algorithm switch 65 may determine that the OCR algorithm 62 should be invoked. As such, the search module 68 may detect, read, or scan the text of the make and/or model of the car pointed at and be provided with a list of candidates by the visual search server 54. For example, the candidates could consist of car dealerships, the make or model of vehicles manufactured by HONDA™, FORD™ or the like.

It should be pointed out that in a situation where, the code-based algorithm 63 such as, for example, a 1D and 2D image tag algorithm or the OCR algorithm 62 is executed, a one or more candidates corresponding to the media content 67 which is pointed at by the camera module 36 and/or detected, read, or scanned by the camera module may be generated. For example, when the code-based algorithm is invoked and the camera module 36 is pointed at or captures an image of a barcode, corresponding data associated with the barcode may be sent to the visual search server which may provide the search module with a single candidate such as, for example, a URL relating to a product in which the barcode is attached or the visual search server could provide a single candidate such as price information or the like. However, according to the exemplary embodiments of the present invention when the OCR algorithm or the code-based algorithm are executed, more than one candidate may be generated when the camera module is pointed at or detects, scans, or reads an image of the OCR data or code-based data. For instance, a 1D/2D barcode could be tagged with price information, serial numbers, URLs, information associated with nearby stores carrying products relating to a target product (i.e., a product pointed at with the camera module) and the like and when this information is sent to the visual search server by the search module, either the visual search server or the algorithm switch of the mobile terminal may determine relevant or associated data to display via display 28.

Based on the set of rules defined in the algorithm switch 65, the algorithm switch 65 could also determine based on a current location of either the mobile terminal or the media content 67 (for example a target object pointed at or an image or the object captured by the camera module 36), which algorithms to apply. That is to say, the rules set in the algorithm switch 65 could be defined such that in one location a given search algorithm (e.g. one of the visual search algorithm, the OCR algorithm or the code-based algorithm) is chosen but in another location a different search algorithm is chosen. For example, the rules of the algorithm switch 65 could be defined such that in a bookstore (i.e., a given location) the code-based algorithm will be chosen such that the camera module is able to 1D/2D barcodes and the like (on books for e.g.) and in another location, for example, outside of the bookstore (i.e., a different location), the rules defined in the algorithm switch may invoke and enable the visual search algorithm 61 thereby enabling the camera module to be pointed at, or capture images of, target objects (i.e., POIs) and send information relating to the target object to the visual search which may provide corresponding information to the search module of the mobile terminal. In this regard, the search module is able to able to switch between various searching algorithms, namely between the visual search algorithm 61, the OCR algorithm 62, and the code-based algorithm 63.

In the exemplary embodiment discussed above, the meta-information inputted and implemented in the algorithm switch 75 may be a sub-set of meta-information available in a visual search system. For instance, while meta-information can include geo-locations, time of day, season, weather, characteristics of the mobile terminal user, product segment, etc., the algorithm switch may only be based on, for example, geo-location and product segment, i.e., a subset of the meta-information available to the visual search system. The algorithm switch 75 is capable of connecting or accessing a set of rules on the mobile terminal or on one or more servers or databases such as for example visual search server 54 and visual search database 51. Rules could be maintained in a memory of the mobile terminal and be updated over-the-air from the visual search server or the visual search database 51.

In an alternative exemplary embodiment, an optional second pass visual search algorithm 64 is provided. This exemplary embodiment addresses a situation in which one or more candidates have been generated through a code-based image tag, (e.g., 1D/2D image tag or barcode) or OCR data. In this regard, additional tags can be detected, read or scanned upon the algorithm switch 75 enabling the second pass visual search algorithm 64. The second pass visual search algorithm 64 can optionally run in parallel, prior to or after any other algorithm such as the visual search algorithm, OCR algorithm 62, and code-based algorithm 63. As an example of the application of the second pass visual search algorithm 64, consider a situation in which the camera module is pointed at or captures an image of a product (e.g. media content 67) such as a camcorder. The rules defined in the algorithm switch 75 may be defined such that product information invokes the code-based algorithm 63 which enables code-based searching by the search module 78, thereby enabling a barcode(s) such as a barcode on the camcorder to be detected, read, or scanned by the camera module enabling the mobile terminal to send information to the visual search server 54 related to the barcode. The visual search server may send the mobile terminal a candidate such as a URL pertaining to a web page which has information relating to the camcorder. Additionally, the rules in the algorithm switch 75 may be defined such that after the code-based algorithm 63 is run the second pass visual search algorithm 64 is enabled (or alternately, second pass visual search algorithm 64 is run prior to or in parallel with the code-based algorithm 63) by the algorithm switch 75 which allows the search module 78 to utilize one or more visual searching capabilities. (Step 804) In this regard, the visual search server 54 may use the information relating to the detection or captured image of the camcorder to find corresponding or related information in its POI database 74, and may send the search module one or more other candidates relating to the camcorder (e.g., media content 67) for display on display 28. (Step 805) For instance, the visual search server 54 may send the search module a list of candidates pertaining to nearby stores selling the camcorder, price information relating to the camcorder, the specifications of the camcorder and the like.

As described above, the second pass visual search server 64 provides a manner in which to obtain additional candidates and thereby obtain additional information relating to a target object, (i.e., POI) when a code-based algorithm or OCR algorithm provides a single candidate. It should be pointed out that results of the candidate obtained based on the code-based algorithm 63 or the OCR algorithm 62, when employed, may have priority over the results of the one or more candidates obtained based on the second pass visual search algorithm 64. As such, the search module 68 may display the candidate(s) resulting from either the code-based algorithm 63 or the OCR algorithm in a first candidate list (having a highest priority) and display the candidate(s) obtained as a result of the second pass visual search algorithm 64 in a second candidate list (having a lower priority than the first candidate list). Alternatively, results or a candidate(s) obtained based on the second pass visual search algorithm 64 may be combined with results or candidate(s) obtained based on either the code-based algorithm 63 or the OCR algorithm 62 to form a single candidate list that can then be outputted by the search module to display 28 which may show all of the candidates in a single list in any defined order or priority. For instance, candidates resulting from either the code-based algorithm 63 or the OCR algorithm 62 may be displayed with a higher priority (in the single candidate list) than candidates resulting from the second pass visual search algorithm 64, or vice versa.

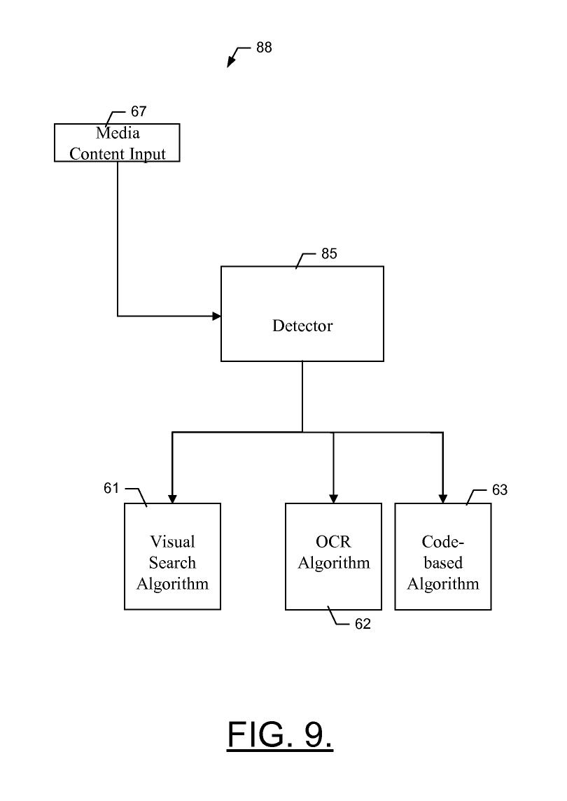

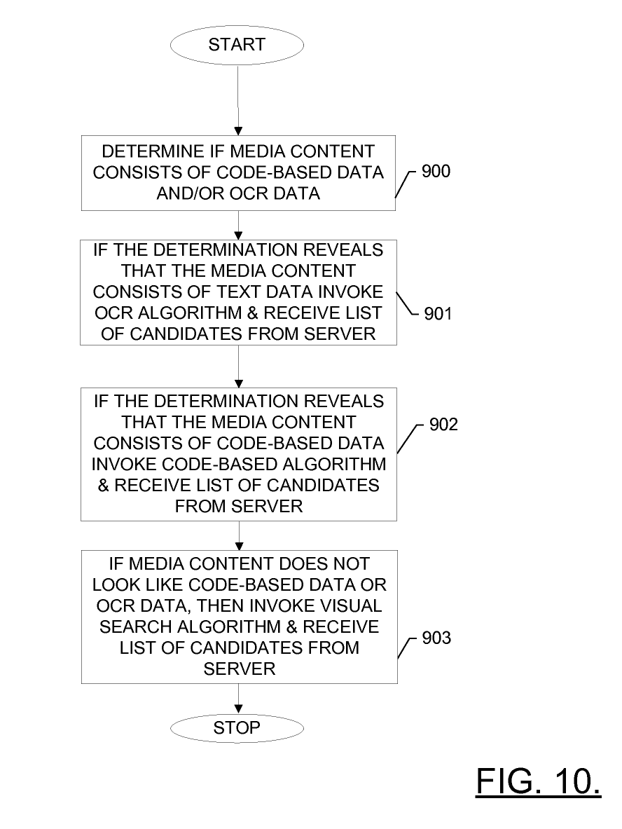

Referring now to FIGS. 9 and 10, another exemplary embodiment of, a flowchart for the operation of a search module for integrating visual searching (e.g., mobile visual searching) with code-based searching and OCR searching utilizing image detection is provided. In this exemplary embodiment, the search module 88 includes a media content input 67, a detector 85, a visual search algorithm 61, an OCR algorithm 62 and a code-based algorithm 63. The media content input 67 may be any device or means of hardware and/or software capable of receiving media content from the camera module 36, the GPS module or any other suitable element of the mobile terminal 10 as well as media content from visual search server 54 or any other server or database. The visual search algorithm 61, the OCR algorithm 62 and the code-based algorithm 63 may be implemented in and embodied by any device or means of hardware and/or software (executed by a processor such as for example controller 20) capable of performing visual searching, OCR searching and code-based searching, respectively. The detector 85 may be any device or means of hardware and/or software (executed by a processor such as controller 20), that is capable of determining the type of media content (e.g., image data and/or video data) that the camera module 36 is pointed at or that the camera module 36 captures as an image. More particularly, the detector 85 is capable of determining whether the media content consists of code-based data and/or OCR data and the like. The detector is capable of detecting, reading or scanning the media content and determining that the media content is code-based tags (barcodes) and/or OCR data (e.g., text), based on a calculation, for example. (Step 900) Additionally, the detector 85 is capable of determining whether the media content consists of code-based data and/or OCR data even when the detector has not outright read the data in the media content (e.g., an image having a barcode or a 1D/2D tag). In this regard, the detector 85 is capable of evaluating the media content, pointed at by the camera module or an image captured by the camera module and determine (or approximate) whether the media content (e.g., image) looks like code-based data and/or text based on the detection of the media content. In situations in which the detector 85 determines that the media content looks as though the media content consists of text data, the detector 85 is capable of invoking the OCR algorithm 62, which enables the search module 88 to perform OCR searching and receive a list of candidates from the visual search server 54 in a manner similar to that discussed above. (Step 901) Additionally, as noted above, the detector 85 is capable of determining (or approximating) if the media content looks like code-based data, for example, the detector could determine that the media content has one or more stripes (without reading the media content, e.g., a barcode in an image) which is indicative of a 1D/2D barcode(s) and enable the code-based algorithm 63 such that the search module 88 is able to perform code-based searching, and receive a list of candidates for the visual search server in a manner similar to that discussed above. (Step 902) If the detector determines that media content 67 does not look like code-based data (e.g., barcodes) or does not look like OCR data, (e.g., text) the detector 85 invokes the visual search algorithm 61 which enables the search module 88 to perform visual searching and receive a list of candidates from the visual search server 54 in a manner similar to that as discussed above. (Step 903)

The code-based data detection performed by detector 85 may be based on a property of image coding systems (e.g., a 1D/2D image coding system(s)) namely, that each of these systems (e.g., 1D/2D image coding system(s)) are designed for reliable recognition. The detector 85 may utilize the position of tags (e.g., barcodes) for reliable extraction of information from the tag images. Most of the tag images can be accurately positioned even in situations where there is significant variation of orientation, lighting and random noises. For example, a QR code(s) has three anchor marks for reliable positioning and alignment. The detector 85 is capable of locating these anchor marks in media content (e.g., image/video) and determining, based on the location of the anchor marks that the media content corresponds to code-based data such as code-based tags or barcodes. Once a signature anchor mark is detected, by the detector 85, the detector will invoke the code-based algorithm 63, which is capable of making a determination, verification or validation that the media content is indeed code-based data such a tag or barcode and the like. The search module may send the code-based data (and/or data associated with the code-based data) to the visual search server 54, which matches corresponding data (e.g., price information, a URL of a product, product specifications and the like) with the code-based data and sends this corresponding data to the search module 88 for display on display 28 of the mobile terminal 10. With respect to detection of OCR data, the detection algorithm 85 is capable of making a determination that the media content corresponds to OCR data based on an evaluation and extraction of high spatial frequency regions of the media content (e.g., image and/or video data). The extraction of high spatial frequency regions can be done, for example, by applying texture filters to image regions, and classify regions based on response from each region, to find the high frequency regions containing texts and characters. The OCR algorithm 62 is capable of making a validation or verification that the media content consists of text data.

By using the detector 85 of the search module 88, the search module is able to swiftly and efficiently switch between the visual search algorithm 61, the OCR algorithm 62 and the code-based algorithm 63. For instance, when the camera module is pointed at or captures an image of an object (i.e., media content) which looks like code-based data the detector may invoke the code-based algorithm 63 and when the camera module is subsequently pointed at or captures an image of another object (i.e., media content) which looks like text (e.g. text on a book or street sign for e.g.), the detector 85 is capable of switching from the code-based algorithm 63 to the OCR algorithm 62. In this regard, the search module 88 does not have to run or execute the algorithms 61, 62 and 63 at the same time which efficiently utilizes processing speed (e.g., processing speed of controller 20) and reserves memory space on the mobile terminal 10.

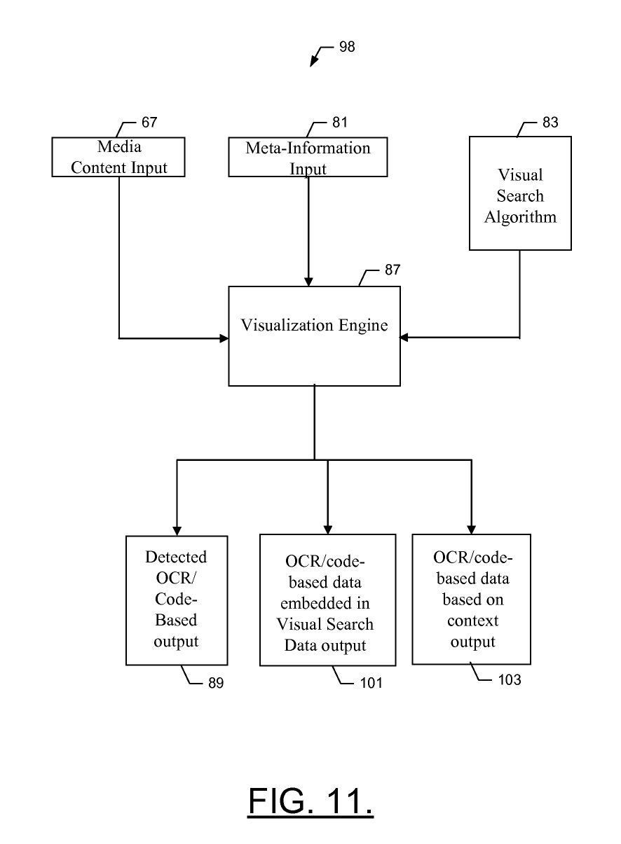

Referring now to FIGS. 11 &12, an exemplary embodiment, and a flowchart relating to the operation of a search module, which integrates visual searching (e.g., mobile visual searching) with code-based data (e.g., 1D/2D image tags or barcodes) and OCR data using visualization techniques are illustrated. The search module of FIG. 11 may accommodate a situation in which multiple types of tags are used on an object (i.e., POI) at the same time. For example, while a QR code and a 2D tag (e.g., barcode) may exist on the same object, this object may also contain a visual search tag (i.e., any data associated with a target object such as POI, for e.g., a URL of a restaurant, coffee shop or the like) in order to provide additional information that may not be included in the QR code or the 2D tag. The search module 98 is capable of enabling the visualization engine to allow the tag information from code-based data (i.e., the QR code and 2D tag in the above e.g.), OCR data and visual search data (i.e., visual search tag in the above e.g.) to all be displayed on display 28 of the mobile terminal.

The search module 98 includes a media content input 67 and meta-information input 81, a visual search algorithm 83, a visual engine 87, a Detected OCR/Code-Based Output 89, an OCR/code-based data embedded in visual search data output 101 and an OCR/code-based data based on context output 103. The media content input 67 may be any means or device of hardware and/or software (executed by a processor such as controller 20) capable of receiving (and outputting) media content from camera module 36, GPS module 70 or any other element of the mobile terminal, as well as media content sent from visual search server 54 or any other server or database. The meta-information input 81 may be any device or means of hardware and/or software (executed by a processor such as controller 20) capable of receiving (and outputting) meta-information (which may be input by a user of mobile terminal 10 via keypad 30 or received from a server or database such as for e.g. visual search server 54) and location information which may be provided by GPS module 70 or received from a server or database such as visual search server 54. Further, the visual search algorithm may be implemented by and embodied by any device or means of hardware and/or software (executed by a processor such as controller 20) capable of performing visual searches for example mobile visual searches. The visualization engine 87 may be any device or means of hardware and/or software (executed by a processor such as controller 20 or a co-processor located internal to visualization engine) capable of receiving inputs from the media content input, the meta-information input and the visual search algorithm. The visualization engine 87 is also capable of utilizing the received inputs from the media content input, the meta-information input and the visual search algorithm to control data outputted to the Detected OCR/Code-Based Output 89, the OCR/code-based data embedded in visual search data output 101 and the OCR/code-based data based on context output 103. The Detected OCR/Code-Based Output 89 may be any device or means of hardware and or software (executed by a processor such as for example controller 20) capable of receiving detected OCR data and/or code-based data from the visualization engine 87 which may be sent to a server such as visual search server 54. Additionally, the OCR/code-based data embedded in visual search data output 101 may be any device or means of hardware and/or software (executed by a processor such as for e.g. controller 20) capable of receiving OCR data and/or code-based data embedded in visual search data from the visualization engine 87, which may be sent to a server such as visual search server 54. Furthermore, the OCR/code-based data based on context output 103 may be any device or means of hardware and/or software (executed by a processor such as for e.g. controller 20) capable of receiving OCR data and/or code-based data based on context (or meta-information) from the visualization engine 87 which may be sent to a server such as visual search server 54.

Regarding the search module 98, when the camera module 36 is pointed at media content (e.g. an image or video relating to a target object, i.e., a POI) or when capturing an image may provide media content, via media content input, to the visualization engine in parallel with meta-information (including but not limited to data relating to geo-location, time, weather, temperature, season, products, consumer segments and any other information of relevance) being provided to the visualization engine. (Step 1100) Also, in parallel with the media content and the meta-information, being input to the visualization engine 87, the visual search algorithm 83 may be input to the visualization engine 87. (Step 1101) The visualization engine 87 may use the visual search algorithm 83 to enable a visual search based on the media content and the meta-information. The visualization engine is also capable of storing the OCR algorithm 62 and the code-based algorithm 63 and executing these algorithms to perform OCR searching and code-based searching, respectively.

As noted above, the media content, pointed at or captured by the camera module, may contain multiple types of tags e.g., code-based tags, OCR tags and visual tags. Consider a situation in which the media content is an image of a product (visual search data) such as a laptop computer, and included in the image is text data (OCR data) relating to the name of the laptop computer, its manufacturer, etc. as well as barcode information (code-based data) relating to the laptop computer. The image of the product could be tagged i.e., associated with information relating to the product, in this example the laptop computer. For example, the image of the laptop computer could be linked or tagged to a URL having relevant information on the laptop computer. In this regard, when the user points the camera module or captures an image of the laptop computer, the mobile terminal may be provided with the URL, by the visual search server 54, for example. Additionally, the text on the laptop computer could be tagged with information such that when the camera module is pointed at the laptop computer, the mobile terminal receives associated information such as for example, a URL of the manufacturer of the laptop computer, by the visual search server 54. Similarly, the barcode on the laptop computer can be tagged with information associated to the laptop computer such as, for example, product information, price, etc. and as such the mobile terminal may be provided with this product and price information, by the visual search server 54, for example. The user of the mobile terminal, via a profile stored in a memory of the mobile terminal 10, or a network operator (e.g. a cellular communications provider) may assign the meta-information such that based on the meta-information, (i.e., context information) the visual search algorithm 83 is invoked and is performed. Additionally, when the visualization engine 87 determines that the visual search results do not include code-based data and/or OCR based data, the visualization engine 87 is capable of activating the OCR algorithm 62 and/or the code-based algorithm 63, stored therein, based on the meta-information. In the above example, the meta-information could be assigned as location such as, for example, location of a store in which case the visual search algorithm will be invoked to enable visual searching capabilities inside the store. In this regard, any suitable meta-information may be defined and assigned for invoking the visual search algorithm. For example, visual searching capabilities enabled by using the visual search algorithm could be invoked based on associated or linked meta-information such as time of day, weather, geo-location, temperature, products, consumer segments and any other information. In addition, when the visualization engine 87 does not detect any OCR and/or code based data in visual search results generated by visual search algorithm 83, meta-information could be assigned such as, for example, location information (e.g., location of a store) in which case the visualization engine 87 will turn on and execute the OCR algorithm and/or the code-based algorithm to perform OCR searching and code-based searching based on the meta-information (i.e., in this example at the location).

In situations in which the visualization engine 87 evaluates the meta-information and invokes the visual search algorithm to perform visual searching on the media content (e.g., image) based on the meta-information, the visualization engine may detect a number of combinations and types of tags in the object. (Step 1102) For instance, if the visualization engine 87 detects OCR tag data (e.g., text) and code-based tag data (a barcode) on the object (laptop computer in the example above), the visualization engine may output this detected OCR data (e.g., text of the manufacturer of the laptop computer) and code-based data (e.g., a barcode on the laptop computer) to the Detected OCR/Code-Based Output 89, which is capable of sending this information to a server such as visual search server 54 which may match associated data with the OCR tag data and the code-based tag data and this associated data (i.e., a list of candidates) (e.g., a URL of the manufacturer for the OCR tag data and a price information for the code-based tag data) may be provided to the mobile terminal for display on display 28. (Step 1103)

Additionally, a user may utilize the visual search database 51, for example, to link one or more tags that are associated with an object (e.g., a POI). As noted above, the visual search input control 98 allows users to insert and store OCR data and code-based data (e.g., 1D bar codes, 2D bar codes, QR codes, Semacode, Shotcode and the like) relating to one or more objects, POIs, products or the like into the visual search database 51. (See FIGS. 3 & 4) For example, a user (e.g., business owner) may utilize a button or key or the like of user input interface 91 to link an OCR tag (e.g., text based tag, such as for example, text of a URL associated with an object (e.g., laptop computer)), and a code-based tag (e.g., barcode corresponding to price information of the laptop computer) associated with the object (e.g., laptop computer). The OCR tag(s) and the code-based tag(s) may be attached to the object (e.g., the laptop computer) which also may contain a visual tag(s) (i.e., a tag associated with visual searching relating to the object).

Moreover, using a button or key or the like of the user input interface 91, the user may create a visual tag(s) associated with the object (e.g., the laptop computer). For example, by using a button or key or the like of user input interface 91, the user may create a visual tag by linking or associating an object(s) or an image of an object with associated information (e.g., when the object or image of the object is a laptop computer, the associated information may be one or more URLs relating to competitors laptops, for example). As such, when the camera module 36 of mobile terminal 10 is pointed at or captures an image of an object (e.g., laptop computer), information associated with or linked to the object may be retrieved by the mobile terminal 10. The OCR tag and the code-based tag may be attached to the object, (e.g., the laptop computer) which also is linked to a visual tag(s) (i.e., a tag associated with visual searching of the object). In this regard, the OCR tag and the code-based tag may be embedded in visual search results. For example, when the visualization engine 87 receives the visual search algorithm 83 and performs visual searching on an object, (once the camera module 36 is pointed at the object or captures an image of the object) the visualization engine 87 may receive visual data associated with the object, such as for example an image(s) of the object, which may have an OCR tag(s) and a code based tag(s) and the object itself may be linked to a visual tag. In this manner, the OCR tag(s) (e.g., text data relating to URL of the laptop computer, for example) and the code-based tag(s) (e.g., barcode relating to price information of the laptop computer, for example) are embedded in visual search results (e.g., an image(s) of an object, such as for example the laptop computer).

The visualization engine 87 is capable of sending this OCR tag(s) and code-based data embedded in the visual search results (e.g., the image(s) of the laptop computer) to the OCR/code-based data embedded in visual search data output 101. (Step 1104) The OCR/code-based data embedded in visual search data output 101 may send data associated with the OCR tag(s), the code-based tag(s) and the visual tag(s) to a server such as visual search server 54, which may match associated data with the OCR tag data (e.g., the text of the URL relating to laptop computer), the code-based data (e.g., the price information of the laptop computer) and the visual search tag data (e.g., web pages of competitors laptop computers) and this associated data may be provided to the mobile terminal for display on display 28. (Step 1105) In this regard, the OCR data, the code-based data and the visual search data may be displayed in parallel on display 28. For example, the information associated with the OCR tag data (e.g., a URL relating to the laptop computer) may be displayed in a column, and the information associated with the code-based tag data (price information associated with the laptop computer) may be displayed in a different column and furthermore the information associated with the visual tag data (e.g., web pages of competitors laptop computers) may be displayed in a different column.

Optionally, if the visualization engine 87 does not detect any tag data in the visual search results generated as a result of executing the visual search algorithm, a user of the mobile terminal 10 may select a placeholder to be used for searching of a candidate. (Step 1106) In this regard, if the visualization engine 87 detects that there is OCR data (e.g., text data) in the visual search data, (e.g., an image(s) of an object(s)) a user of mobile terminal 10, via keypad 30, may select the OCR data (e.g., text data as a placeholder which may be sent by the visualization engine 87 to the OCR/code-based data embedded in visual search data output 101. Alternatively, a network operator (e.g., a cellular communications provider) may include a setting in the visualization engine 87 which automatically selects keywords associated with descriptions of products to be used as the placeholder. For instance, if the visualization engine 87 detects text on a book in the visual search results such as for example the title of the book Harry Potter and the Order of The Phoenix,™ the user (or the visualization engine 87) may select this text as a placeholder to be sent to the OCR/code-based data embedded in visual search data output 101. The OCR/code-based data embedded in visual search data output 101 is capable of sending the placeholder (in this e.g., text of the book (Harry Potter and the Order of The Phoenix™) to a server such as, for example, visual search server 54 which determines and identifies whether there is data associated with the text stored in the visual search server and if there is associated data, i.e., a list of candidates (e.g., a web site relating to a movie associated with the Harry Potter and the Order of The Phoenix™ book and/or a web site of a bookstore selling the Harry Potter and the Order of The Phoenix™ book and the like) the visual search server 54 sends this data (e.g., these websites) to the mobile terminal 10 for display on display 28. (Step 1107)

Additionally or alternatively, if the visualization engine 87, does not detect any tag data, such as for example, OCR tag data and/or code-based tag data in the visual search results, the visualization engine 87 may nevertheless activate and turn on the OCR and code-based algorithms, stored therein, based on meta-information (i.e., context information). If the visualization engine 87 receives search results generated by execution of the visual search algorithm 83 relating to an image(s) of an object(s) and the visualization engine 87 determines that there is no OCR and/or code-based tag data in the search results, (i.e., the image(s)) based on the assigned meta-information, the visualization engine may nonetheless turn on the OCR and code-based searching algorithms and perform OCR and code-based searching. (Step 1108)

For instance, when the meta-information is assigned as location of a store (for example) the visualization engine 87 may invoke and execute the OCR and code-based algorithms and perform OCR and code-based searching when the GPS module 70 sends location information to the visualization engine 87, via meta-information input 81, indicating that the mobile terminal 10 is within a store. In this regard, the visualization engine detects code-based data (e.g., barcode containing price information relating to a product (e.g., laptop computer)) and OCR based data (e.g., text data such as, for example, a URL relating to a product (e.g., laptop computer)) when the camera module 36 is pointed at or takes an image(s) of an object(s) having OCR data and/or code-based data. (It should be pointed out that the meta-information may be assigned as any suitable meta-information including but not limited to time, weather, geo-location, location, temperature, product or any other suitable information. As such, location is one example of the meta-information. For example, in the above example, the meta-information could be assigned as a time of day such as between the hours of 7:00 AM and 10:00 AM and when a processor such as controller 20 sends the visualization engine 87 the current time that is within the hours of 7:00 AM to 10:00 AM, via the meta-information input 81, the visualization engine may invoke the OCR/code-based data algorithms) The visualization engine 87 is capable of sending the OCR and the code-based data to the OCR/code-based data based on context output 103. (Step 1109) The OCR/code-based data based on context output 103 may send OCR and code-based data to a server such as visual search server 54, which is capable of matching data associated with the OCR data (e.g., URL of the manufacturer of the laptop computer) and the code-based tag data (e.g., price information (embedded in a barcode) relating the laptop computer) and this associated (i.e., list of candidates) data may be provided to the mobile terminal for display on display 28. (Step 1110)

In view of the foregoing, the search module 98 allows the mobile terminal 10 to display, (in parallel) at the same time, a combination of data relating to different types of tags, as opposed to showing results or candidates from a single type of tag(s) (e.g., code-based) or switching between results or candidates relating to different types of tags.

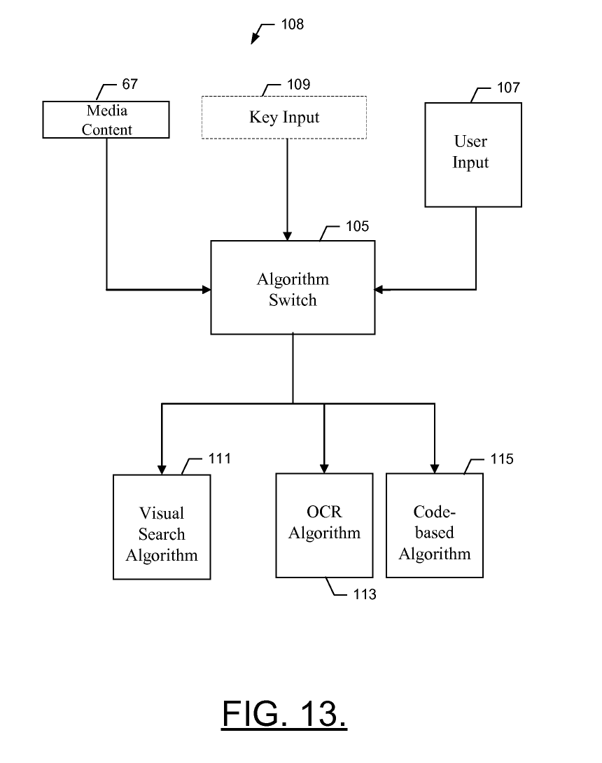

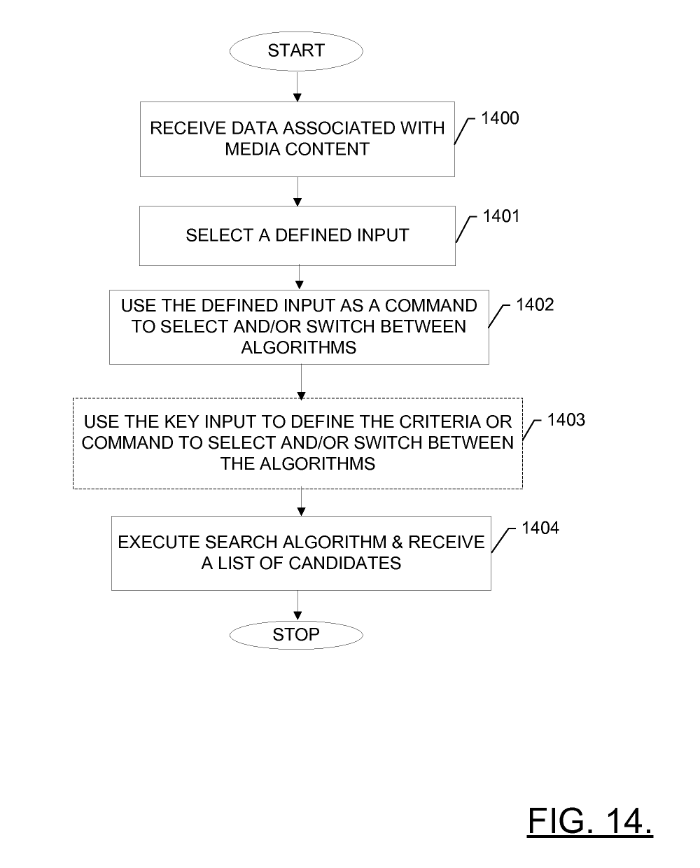

Referring now to FIGS. 13 and 14, an exemplary embodiment of a search module for integrating visual searches (e.g., mobile visual searches) with code-based searches and OCR searches utilizing a user's input is illustrated. The search module 108 is capable of using inputs of a user of the mobile terminal to select and/or switch between the visual search algorithm 111, the OCR algorithm 113 and the code-based algorithm 115. The media content input 67 may be any device or means in hardware and/or software (executed by a processor such as controller 20) capable of receiving media content from camera module 36 or any other element of the mobile terminal as well as from a server such as visual search server 54. The key input 109 may be any device or means in hardware and/or software capable of enabling a user to input data into the mobile terminal. The key input may consist of one or more menus or one or more sub-menus, presented on a display or the like, a keypad, a touch screen on display 28 and the like. In one exemplary embodiment, the key input may be the keypad 30. The user input 107 may be any device or means in hardware and/or software capable of outputting data relating to defined inputs to the algorithm switch 105 of the mobile terminal. The algorithm switch 105 may utilize one or more of the defined inputs to switch between and/or select the visual search algorithm 111, or the OCR algorithm 113 or the code-based algorithm 115. For example, one or more of the defined inputs may be linked to or associated with one or more of the visual search algorithm 111, or the OCR algorithm 113 or the code-based algorithm 115. As such, when a defined input(s) is received by the algorithm switch 105, the defined input(s) may trigger the algorithm switch 105 to switch between and/or select a corresponding search algorithm among the visual search algorithm 111, or the OCR algorithm 113 or the code-based algorithm 115.

In an exemplary embodiment, the user input 107 may be accessed in one or more menu and/or sub-menus that are selectable by a user of the mobile terminal and shown on the display 28. The one or more defined inputs include but are not limited to a gesture (as referred to herein a gesture may be a form of non-verbal communication made with a part of the body, or used in combination with verbal communication), voice, touch or the like of user of the mobile terminal. The algorithm switch 105 may be any device or means in hardware and/or software (executed by a processor such as controller 20) capable of receiving data from media content input 67, key input 109 and user input 107 as well as selecting and/or switching between search algorithms such as the visual search algorithm 111, the OCR algorithm 113 and the code-based algorithm 115. The algorithm switch 105 has speech recognition capabilities. The visual search algorithm 111, the OCR algorithm 113 and the code-based algorithm 115 may each be any device or means in hardware and/or software (executed by a processor such as controller 20) capable of performing visual searching, OCR searching and code-based searching, respectively.

In the search module 108, the user input 107 of the mobile terminal may be pre-configured with the defined inputs by a network operator or cellular provider, for example. Alternatively or additionally, the user of the mobile terminal may determine and assign the inputs of user input 107. In this regard, the user may utilize the keypad 30 or the touch display of the mobile terminal to assign the inputs (e.g. a gesture, voice, touch, etc. of the user) of user input 107 which may be selectable in one or more menus and/or sub-menus and which may be utilized by algorithm switch 105 to switch between and/or select the visual search algorithm 111, or the OCR algorithm 113 or the code-based algorithm 115, as noted above.

Optionally, instead of using user input 107, to select a defined input which enables the algorithm switch 105 to select one or the searching algorithms 111, 113 and 115, the user may utilize key input 109. In this regard, the user may utilize the options on the touch screen (e.g., menu/sub-menu options) and/or type criteria, using keypad 30, that he/she would like to use to enable the algorithm switch 105 to switch and/or select between the visual search algorithm 111, the OCR algorithm 113 and the code-based algorithm 115. The touch screen options and the typed criteria may serve as commands or may consist of a rule that instructs the algorithm to switch between and/or select one of the search algorithms 111, 113 and 115.

An example of the manner in which the search module 108 may be utilized will now be provided for illustrative purposes. It should be noted however that the various other implementations and applications of the search module 108 are possible without departing from the spirit and scope of the present invention. Consider a situation in which the user of the mobile terminal 10 points the camera module 36 at an object (i.e., media content) or captures an image of the object. Data relating to the object pointed at or captured in an image by the camera module 36 may be received by the media content input and provided to the algorithm switch 105. (Step 1400) The user may select a defined input via user input 107. (Step 1401) For example, the user may select the voice input (See discussion above). In this regard, by speaking the user's voice may be employed to instruct the algorithm switch 105 to switch between and/or select one of the searching algorithms 111, 113 and 115. (Step 1402) (Optionally, the user of the mobile terminal may utilize key input 109 to define a criteria or a command for the algorithm switch to select and/or switch between the visual search algorithm, the OCR algorithm and the code-based algorithm (Step 1403)) (See discussion below) If the user is in a shopping mall, for example, the user might say “use code-based searching in shopping mall” which instructs the algorithm switch 105 to select the code-based algorithm 115. Selection of the code-based algorithm 115 by the algorithm switch enables the search module to perform code-based searching on the object pointed at or captured in an image by the camera module as well as other objects in the shopping mall. In this regard, the code-based algorithm enables the search module to detect, read or scan a code-based data such as a tag (e.g., a barcode) on the object (e.g. a product). Data associated with the tag may be sent from the search module to the visual search server which finds matching data associated with the tag and provides this data i.e., a candidate(s) (e.g., price information, a web page containing information relating to the product, etc.) to the search module 108 for display on display 28. (Step 1404) In a similar manner, the user could also use his/her voice to instruct the algorithm switch 105 to select the OCR algorithm 113 or the visual searching algorithm 111. For example, the user might say “perform OCR searching while driving” and pointing the camera module at a street sign (or e.g., “perform OCR searching while in library) which instructs the algorithm switch 105 to select the OCR algorithm and the enables the search module 108 to perform OCR searching. In this regard, the text on the street sign may be detected, read or scanned by the search module and data associated with the text may be provided to the visual search server 54 which may provide corresponding data i.e., a candidate(s) (e.g., map data relating to the name of a city on the street sign, or the name of a book in a library) to search module for display on display 28. Additionally, the user could say (for example) “perform visual searching while walking along street” which instructs the algorithm switch 105 to select the visual searching algorithm 111 which enables the search module 108 to perform visual searching such as mobile visual searching. As such, the search module is able to capture an image of an object (e.g., image of a car) along the street and provide data associated with or tagged on the object to the visual search server 54 which finds matching associated data, if any, and sends this associated data i.e., a candidate(s) (e.g., web links to local dealerships, etc.) to the search module for display on display 28.

Employing speech recognition technology, the algorithm switch 105 may identify keywords spoken by the user to select the appropriate searching algorithm 111, 113 and 115. In an alternative exemplary embodiment, these keywords include but are not limited to “code,” “OCR,” and “visual.” If multiple types of tags (e.g., code-based tags (e.g., barcodes), OCR tags, visual tags) are on or linked to media content such as an object, the search module 108 may be utilized to retrieve information relating to each of the tags. For instance, the user may utilize an input of user input 107 such as the voice input and say “perform code-based searching and perform OCR searching as well as visual searching” which instructs the algorithm switch to select an execute (either in parallel or sequentially) each of the searching algorithms 111, 113 and 115, which enables the search module to perform visual searching, OCR searching and code-based searching on a single object with multiple types of tags.

Moreover, the user could select the gesture input of user input 107 to be used to instruct the algorithm switch 105 to switch between and/or select and run the visual search algorithm 111, the OCR algorithm 113 and the code-based algorithm 115. For instance, the gesture could be defined as raising a hand of the user while holding the mobile terminal (or any other suitable gesture such as waving a hand (signifying hello) while holding the mobile terminal). The gesture, i.e., raising of a hand holding the mobile terminal in this example, can be linked to or associated with one or more of the visual search, OCR and code-based algorithms 111, 113 and 115. For example, the raising of a hand gesture can be linked to the visual searching algorithm 111. In this regard, the algorithm switch 105 receives media content (e.g. an image of a store), via media content input 67, and when the user raises his/her hand (for example above the head) the algorithm switch receives instructions from the user input 107 to select and run or execute the visual searching algorithm 111. This enables the search module to invoke the visual searching algorithm which performs visual searching on the store and sends data associated with the store (e.g., the name of the store) to a server such as the visual search server 54 which matches data associated (e.g., telephone number and/or web page of the store) to the store, if any, and provides this associated data i.e., a candidate(s) to search module for display on display 28. The gesture of the user may be detected by a motion sensor of the mobile terminal (not shown).

Alternatively, as noted above, the user of the mobile terminal 10, may utilize the key input 109 to instruct the algorithm switch 105 to select an a searching algorithm 111, 113 and 115. In this regard, consider a situation in which the user points the camera module at a book in a bookstore or captures an image of the bookstore (e.g. media content). Data relating to the book may be provided to the algorithm switch 105, via media-content input 67 and the user may utilize keypad 30 to type “use OCR searching in bookstore” (or the user may a select an option in a menu on the touch display such as for e.g. to use OCR searching in a bookstore) The typed instruction “use OCR searching in bookstore” is provided to the algorithm switch 105, via key input 109 and the algorithm switch uses this instruction to select and run or execute the OCR algorithm 113. This enables the search module to run the OCR algorithm and receive OCR data relating to the book (text on the cover of the book) which may be provided to the visual search server 54 which finds corresponding matching information, if any, and provides this matched information to the search module for display on display 28.

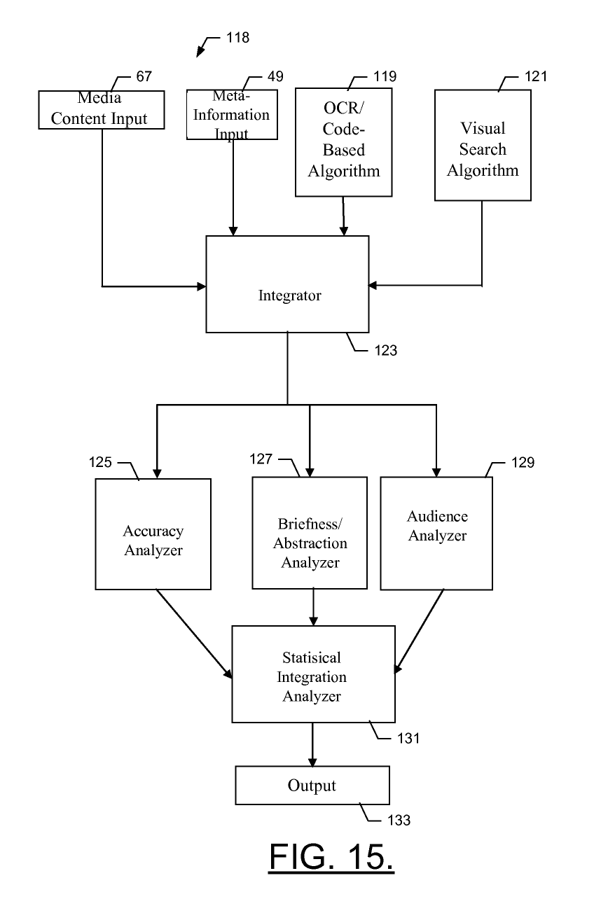

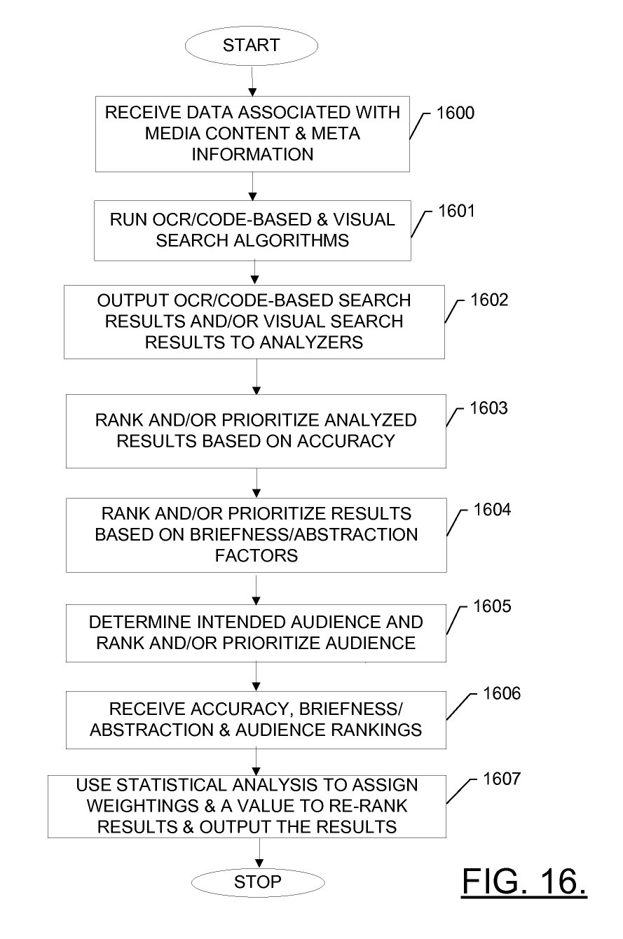

Referring now to FIGS. 15 and 16, an exemplary embodiment, and a flowchart of operation of a search module for integrating visual searching with code-based searching and OCR searching using statistical processing are provided. The search module 118 includes a media content input 67, a meta information input, an OCR/code-based algorithm 119, a visual search algorithm 121, an integrator 123, an accuracy analyzer 125, a briefness/abstraction level analyzer 127, an audience analyzer 129, a statistical integration analyzer 131 and an output 133. The OCR/code-based algorithm 119 may be implemented in and embodied by any device or means of hardware and/or software (executed by a processor such as for e.g. controller 20) capable of performing both OCR searching and code-based searching. The visual search algorithm 121 may be implemented in and embodied by any device and/or means of hardware and/or software (executed by a processor such as for e.g. controller 20) capable of performing visual searching such as mobile visual searching. The OCR/code-based algorithm 119 and the visual search algorithm 121 may be run or executed in parallel or sequentially. The integrator 123 may be any device and/or means of hardware and/or software (executed by a processor such as e.g., controller 20) capable of receiving media-content, via media content input 67, meta-information, via meta-information input 49, and executing the OCR/code based algorithm and the visual search algorithm to provide OCR and code-based search results as well as visual search results. The data received by the integrator 123 may be stored in a memory (not shown) and output to the accuracy analyzer 125, the briefness/abstraction analyzer 127 and the audience analyzer 129.

The accuracy analyzer 125 may be any device and/or means of hardware and/or software (executed by a processor such as for e.g. controller 20) capable of receiving and analyzing the accuracy of the OCR search results, the code-based search results and the visual search results generated from the OCR/code-based algorithm 119 and the visual search algorithm 121. The accuracy analyzer 125 is able to transfer accuracy data to the statistical integration analyzer 131. The briefness/abstraction analyzer 127 may be any device and/or means of hardware and/or software (executed by a processor such as for e.g. controller 20) capable of receiving and analyzing the briefness and abstraction levels of data arising from the OCR search results, the code-based search results and the visual search results generated from the OCR/code-based algorithm 119 and the visual search algorithm 121. The briefness/abstraction analyzer is able to transfer its analysis data to the statistical integration analyzer 131. The audience analyzer 127 may be any device and/or means of hardware and or software (executed by a processor such as for e.g. controller 20) capable of receiving, analyzing and determining the intended audience of the OCR search results, the code-based search results and the visual search results generated from the OCR/code-based algorithm 119 and the visual search algorithm 121. The audience analyzer 129 is also able to transfer data relating to the intended audience of each of the OCR and code-based search results as well as the visual search results to the statistical integrator analyzer 131.

The statistical integration analyzer 131 may be any device and/or means of hardware or software (executed by a processor such as controller 20) capable of receiving data and results from the accuracy analyzer 125, the briefness/abstraction analyzer 127 and the audience analyzer 129. The statistical integration analyzer 131 is capable of examining the data sent from the accuracy analyzer, the briefness/abstraction analyzer and the audience analyzer and determining the statistical accuracy each of the results generated from the OCR search, the code-based search and the visual search provided by the OCR/code-based algorithm 119 and the visual search algorithm 121, respectively. The statistical integration analyzer 131 is capable of using the accuracy analyzer results, the briefness/abstraction analyzer results and the audience analyzer results to apply one or more weightings factors (for e.g. being multiplied by a predetermined value) to each of the OCR and code-based search results, as well as the visual search results. In this regard, the statistical integration analyzer 131 is able to determine and assign a percentage of accuracy to each of the OCR and code-based search results, as well as the visual search results. For example, if the statistical integration analyzer 131 determines that the OCR results are within a range of 0% to 15% accuracy, the statistical integration analyzer 131 may multiply the respective percentage by a value of 0.1 (or any other value) and if the statistical integration analyzer 131 determines that code-based search results are within a range of 16% to 30% accuracy, the statistical integration analyzer 131 may multiply the respective percentage by 0.5 (or any other value).

Additionally, if the statistical integration analyzer 131 determines that the visual search results were within a range of 31% to 45% accuracy, for example, the statistical integration analyzer 131 could multiply the respective percentage by a value of 1 (or any other value). The statistical integration analyzer 131 is also capable of discarding results that are not within a predefined range of accuracy. (It should be pointed out that typically results are not discarded unless they are very inaccurate (e.g. code-based search results are verified as incorrect). The less accurate results are usually processed to have a low priority.) The statistical integration analyzer 131 is further capable of prioritizing or ordering the results from each of the OCR search, the code-based search and the visual search. For example, if the statistical integration analyzer 131 determines that the results from the OCR search are more accurate than the results from the code-based search which are more accurate than the results from the visual search, the statistical integration analyzer 131 may generate a list which includes the OCR results first, (e.g., highest priority and higher percentage of accuracy) followed by the code-based results (e.g., second highest priority with second highest percentage of accuracy) and thereafter followed by (i.e., at the end of the list) the visual search results (e.g., lowest priority with the lowest percentage of accuracy).

Moreover, the statistical integration analyzer 131 may determine which search results among the OCR search results, the code-based search results and the visual search results generated by the OCR/code based search algorithm 119 and the visual search algorithm 121 respectively to transfer to output 133. The determination could be based on the search results meeting or exceeding a pre-determined level of accuracy. The output 133 may be any device or means of hardware and/or software capable of receiving the search results (e.g., data associated with media content such as an image of a book) provided by the statistical integration analyzer 131 and for transmitting data associated with these results (e.g., text data on the book) to a server such as visual search server 54 which determines if there matching data associated, in a memory of the server 54, with the search results, if any, and transmitting the matching data (i.e., candidates such as web pages selling the book for example) to the search module 118 for display on display 28.

An example of the manner in which the search module 118 may operate will now be provided for illustrative purposes. For instance, the search module 118 may operate under various other situations without departing from the spirit and scope of the present invention. Consider a situation in which the user points the camera module 36 at an object (e.g., a plasma television) or captures an image or a video clip of the object (e.g. of media content). Information relating to the object may be provided by the camera module to the integrator 123, via media content input 67 and stored in a memory (not shown). Additionally, meta-information such as for example information relating to properties of the media content, (e.g. timestamp, owner etc.) geographic characteristics of the mobile terminal, (e.g., current location or altitude) environmental characteristics (e.g., current weather or time), personal characteristics of the user (e.g., native language or profession), characteristics of the user's online behavior and the like may be stored in a memory of the mobile terminal such as memory 40 in a user profile, for example or provided to the mobile terminal, by a server such as visual search server 54. The meta-information may be input to the integrator, via meta-information input 49, and stored in a memory (not shown). (Step 1600) This meta-information may be linked to or associated with the OCR/code-based search algorithm 119 and/or the visual search algorithm 121. For example, meta-information such as time of day can be linked to or associated with the visual search algorithm 121, which enables the integrator 123, to use the received visual search algorithm 121 to perform visual searching capabilities based on the object, i.e., the plasma television (e.g., detecting, scanning or reading visual tags attached or linked to the plasma television) during the specified time of day. Additionally, meta-information can be associated or linked to the OCR algorithm 119, for example, which enables the integrator 123 to receive and invoke OCR based algorithm 119 to execute or perform OCR searching (e.g., detecting, reading or scanning text on the plasma television relating to a manufacturer, for example) on the object, i.e. the plasma television when the mobile terminal is in a pre-defined location, for e.g., Paris, France. (Step 1601) Furthermore, meta-information such as, for example, location may be associated or linked to the code-based algorithm 119 and when the code-based algorithm 119 is received by the integrator 123, the integrator 123 may execute the code-based algorithm 119 to perform code-based searching (e.g., detecting a barcode) on the plasma television when the user of the mobile terminal 10 is in a location where code-based data is prevalent (e.g. stores, such as bookstores, grocery stores, department store and the like). It should be noted that the OCR/code-based algorithm 119 and the visual search algorithm 121 may be executed or run in parallel.

The integrator 123 is capable of storing the OCR search results, the code-based search results and the visual search results and outputting these various search results to each of the accuracy analyzer 125, the briefness/abstraction analyzer 127 and the audience analyzer 129. (Step 1602) The accuracy analyzer 125 may determine the accuracy or the reliability of the OCR search results (e.g., accuracy of the text on the plasma television), the code-based search results (e.g. accuracy of the detected barcode on the plasma television) and the visual search results (e.g., accuracy of a visual tag linked to or attached to the plasma television, this visual tag may contain data associated with a web page of the plasma television, for example). The accuracy analyzer 125 may rank or prioritize the analyzed results depending on a highest to lowest accuracy or reliability. (Step 1603) In this regard, OCR search results could be ranked higher (i.e., if the OCR results have the highest accuracy, for e.g.) than code-based search results which may be ranked higher than the visual search results (i.e., if the code-based search results are more accurate than the visual search results). This accuracy data such as the rankings and/or prioritization(s) may be provided, by the accuracy analyzer, to the statistical integration analyzer 131.

Moreover, the briefness/abstraction analyzer 127 may analyze the OCR search results, the code-based search results and the visual search results received from the integrator 123 and rank or prioritize these results based on briefness and abstraction factors or the like. (Step 1604) (It should be pointed out that different abstraction factors are applied since some abstraction factors are more appropriate for different audiences. For example, a person with expertise in a certain domain may prefer description on a higher abstraction level, such that a brief description of data in search results is enough, whereas people with less experience in a certain domain might need a more detailed explanation of data in search results. In an alternative exemplary embodiment, data having a high abstraction level (i.e., brief description of data in search results) could be ranked higher or prioritized above data that has a lower abstraction level (i.e., more detailed description of data in search results) and a link could be attached to the search results having the high abstraction level such that more detailed information may be associated with the search results that are provided to the statistical integration analyzer 131 (see discussion below).) For instance, if the OCR search results consist of 100 characters of text, the visual search results consist of an image having data relating to a map or a street sign, for example, and the code-based search results consist of a 1D barcode, the briefness/abstraction analyzer 127 may determine that the code-based search results (i.e., the barcode) consists of less data (i.e., is the most brief form (i.e., highest abstraction level) of data among the search results). Additionally, the briefness/abstraction analyzer 127 may determine that the visual search results (e.g., the map data or data of a street sign) may consist of more data than the code-based search results but less data than the OCR search results (e.g., the 100 characters of text). In this regard, the briefness/abstraction analyzer 127 may determine that the visual search results consists of the second most brief form of data (i.e., second highest abstraction level) among the search results and that the OCR search results consists of the third most brief form of data (i.e., third highest abstraction level) among the search results. As such, the briefness/abstraction analyzer 127 is capable of assigning a priority or ranking these search results. For example, the briefness/abstraction analyzer 127 may rank and/or prioritize (in a list for example) the code-based search results first (i.e., highest priority or rank), followed by the visual search results (i.e., second highest priority or rank), and thereafter by the OCR search results (i.e., lowest priority or rank). These rankings and/or prioritizations, as well as any other rankings and/or prioritizations generated by the briefness/abstraction analyzer 127 may be provided to the statistical integration analyzer 131, which may utilize these rankings and/or prioritizations to dictate or determine the order in which data associated with the search results will be provided to output 133 and sent to the visual search server 54, which may match associated data, if any, (i.e., candidates such as for e.g., price information, product information, maps, directions, web pages, yellow page data or any other suitable data) with the search results and sends this associated data to the search module 118 for display of the candidates on display 28 in the determined order. For example, price information followed by product information, etc.

Additionally, the audience analyzer 129 is capable of determining the intended audience of each of the OCR search results, the code-based search results and the visual search results. In the example above, in which the object consisted of the plasma television, audience analyzer 129 may determine that the intended audience was a user of the mobile terminal 10. Alternately, for example, the audience analyzer may determine that the intended audience is a friend or the like of the user. For example, in instances in which the audience analyzer 129 determines that the intended audience of the OCR search results is the user, the statistical integration analyzer 131 may assign the OCR search results with a priority or ranking that is higher than visual search results intended for a friend of the user (or any other intended audience) and/or code-based search results intended for a friend of the user (or any other intended audience). (Step 1605) The audience analyzer may send the rankings and/or prioritizations of the intended audience information to the statistical integration analyzer 131.

The statistical integration analyzer 131 is capable of receiving the accuracy results from the accuracy analyzer 125, the rankings and/or prioritizations generated by the briefness/abstraction analyzer 127 and the rankings and/or prioritizations relating to the intended audience of the search results from the audience analyzer 129. (Step 1606)

The statistical integration analyzer 131 is capable of determining an overall accuracy of all the data received from the accuracy analyzer 125, the briefness/abstraction analyzer 127 and the audience analyzer 129 as well as evaluating the importance of data corresponding to each of the search results and on this basis the statistical integration analyzer is capable of re-prioritizing and/or re-ranking the visual search results, the code-based search results and the OCR search results. The most accurate and most important search results may be assigned a highest rank or a highest percentage priority value (e.g., 100%), for example, using a weighting factor such as a predetermined value (e.g., 2) that is multiplied by a numerical indicator (e.g., 50) corresponding to the search result(s). On the other hand, less accurate and less important search results may be assigned a lower rank (priority) or a lower percentage priority value (e.g., 50%), for example, using a weighting factor such as a predetermined value (e.g., 2) that is multiplied by a numerical indicator (e.g., 25) corresponding to the search result(s). (Step 1607) It should be pointed out that these weightings factors can be adjusted in real-time as a user points the camera module at a target object (i.e., a POI). Given that the properties of different search results, such as accuracy and briefness changes over time as a user points a mobile terminal at an object, the weightings are adjusted in real-time accordingly. The statistical integration analyzer 131 may provide these re-prioritized and/or re-ranked search results to the output 133 which sends the search results to the visual search server 54. The visual search server 54 determines whether there is any associated data, for e.g., stored in POI database 74, that matches the search results and this matched data, (i.e., candidates) if any, are sent to the search module 118 for display on display 28 in an order corresponding to the re-prioritized and/or re-ranked search results.

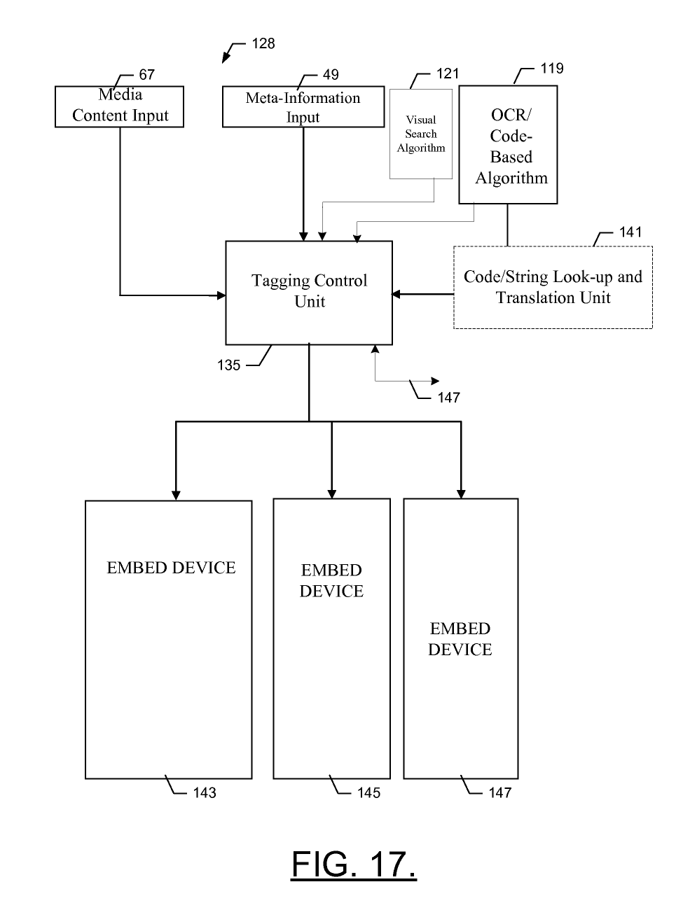

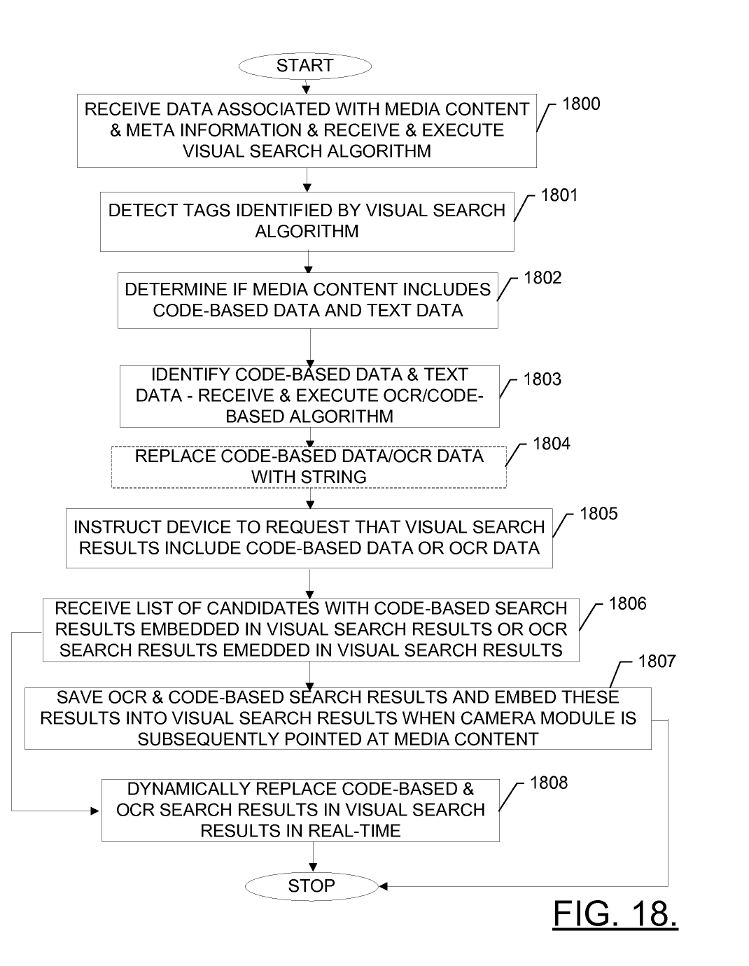

Referring now to FIGS. 17 and 18, an exemplary embodiment, and a flowchart of operation of a search module for adding and/or embedding code-based tags and/or OCR tags into visual search results are provided. The search module 128 includes a media content input 67, a meta-information input, a visual search algorithm 121, an OCR/code based algorithm 119, a tagging control unit 135, an embed device 143, an embed device 145, an embed device 147 and optionally a code/string look-up and translation unit 141. In an exemplary embodiment the code/string look-up and translation unit may include data such as text characters and the like stored in a look-up table.

The tagging control unit 135 may be any device or means in hardware and/or software (executed by a processor such as controller 20 or a co-processor located internal to the tagging control unit) capable of receiving media content (e.g., image of an object, video of an event related to a physical object, a digital photograph of an object, a graphical animation, audio, such as a recording of music played during an event near a physical object and the like), via media content input 67, (from, for example, the camera module 36), meta-information, via meta information input 49, the visual search algorithm 121 and the OCR/code-based algorithm 119. As described above, the meta-information may include but is not limited to geo-location data, time of day, season, weather, and characteristics of the mobile terminal user, product segments or any other suitable data associated with real-world attributes or features. This meta-information may be pre-configured on the user's mobile terminal 10, provided to the mobile terminal 10 by the visual search server 54, and/or input by the user of the mobile terminal 10 using keypad 30. The tagging control unit 135 is capable of executing the visual search algorithm 121 and the OCR/code based algorithm 119. Each of the meta-information may be associated with or linked to the visual search algorithm 121 or the OCR/code-based algorithm 119. In this regard, the tagging control unit 135 may utilize the meta-information to determine which algorithm among the visual search algorithm 121 or the OCR/code-based algorithm 119 to execute. For instance, meta-information such as weather may be associated or linked to the visual search algorithm and as such the tagging control unit 135 may execute the visual search algorithm when a user points the camera module or captures an image of the sky, for example. Meta-information such as location of a store could be linked to the code-based algorithm 119 such that the tagging control unit will execute code-based searching when the user points the camera module at barcodes on products, for example. Meta-information such as location of a library could be linked to the OCR algorithm 119 such that the tagging control unit 135 will execute OCR based searching when the user points the camera module at books, for example. The code/string look-up and translation unit 141 may be any device or means of hardware and/or software (executed by a processor such as controller 20 or a co-processor located internal to the code/string look-up and translation unit 141) capable of modifying, replacing or translating OCR data (e.g., text data) and code-based data (e.g., barcodes) generated by the OCR/code-based algorithm 119. For example, the code/string look-up and translation unit 141 is capable of translating text, identified by the OCR/code-based algorithm 119, into one or more languages (e.g., translating text in French to English) as well as converting code-based data such as barcodes, for example, into other forms of data (e.g., translating a barcode on a handbag to its manufacturer e.g., PRADA™)

The search module 128 will now be described in reference to an example. It should be pointed out that several example situations apply in which the search module can operate and this example is merely provided for illustrative purposes. Suppose that meta-information consists of product information that is associated with or linked to the visual search algorithm 121. In this regard, when the user of the mobile terminal points the camera module 36 at a product such as a camcorder, for e.g., the tagging control unit 135 may receive data associated with camcorder (e.g., media content) and receive and invoke the an algorithm such as for example, visual search algorithm 121 in order to perform visual searching on the camcorder. (Step 1800) For instance, the tagging control unit 135 may receive data relating to an image of the camcorder captured by camera module 36. Data relating to the image of the camcorder may include one or more tags, e.g., visual tags (i.e., tags associated with visual searching) embedded in the image of the camcorder which is associated with information relating to the camcorder (e.g., web pages providing product feature information for the camcorder, which may be accessible via a server such as visual search server 54). (Step 1801) The tagging control unit 135 may also detect that the image of the camcorder includes a barcode (i.e., code-based tag) and text data (i.e., OCR data) such as the text of a manufacturer's name of the camcorder. (Step 1802) Based on the above detection, the tagging control unit 135 may invoke the code-based algorithm 119 to perform code-based searching on the camcorder as well. (The tagging control unit 135 may also invoke the OCR algorithm 119 to perform OCR searching on the camcorder. (See discussion below)) (Step 1803) (Optionally, the code-based data and the text data may be replaced, modified or translated with data such as for e.g., character strings by code/string look-up and translation unit. (See discussion below) (Step 1805)) As such, the tagging control unit 135 may determine that the information relating to the detected barcode will be included in the visual search results and instructs embed device 143 to request that the visual search results include or embed the information relating to the barcode. (Alternately, the tagging control unit 135 may determine that the information relating to the detected text data will be included in the visual search results and instructs embed device 145 to request that the visual search results include or embed the information relating to the text data. (See discussion below)) (Step 1805) The embed device 143 receives this instruction and sends a request to the visual search server 54 for data associated with a visual tag of the camcorder such as web page (i.e., a candidate) relating to the camcorder having the information relating to the barcode embedded therein (e.g., price information of the camcorder). (Alternately, the embed device 145 receives this instruction and sends a request to the visual search server 54 for data associated with a visual tag of the camcorder such as web page (i.e., a candidate) relating to the camcorder having the information relating to the text data embedded therein (e.g., name of the manufacturer of the camcorder). (See discussion below)) The visual search server 54 determines if there is any data matching or associated with the visual tag (stored in a memory, such as POI database 74) such as the web page and provides this web page with the price information (i.e., the information embedded in the barcode) (or with the manufacturer's name) to the embed device 143 (or embed device 145) of the search module 128 for display on display 28. In this regard, the embed device 143 is capable of instructing the display 28 to show the web page with the price information of the camcorder embedded in the web page and its associated meta-information. (Alternatively, embed device 145 is capable of instructing the display 28 to show the web page with the manufacturer's of the camcorder's name embedded in the web page. (See discussion below)) (Step 1806)

The embed device 143 is capable of saving information relating to the barcode (i.e., code based tag data) in its memory (not shown). (The embed device 145 is also capable of saving information relating to the manufacturer's name (i.e., OCR tag data) in its memory (not shown) (See below)) As such, whenever the user subsequently points the camera module at the camcorder, price information (or the manufacturer's name) relating to the camcorder will be included in the web page provided by the visual search 54 to the search module 128 for display on display 28. The price information (or text such as the manufacturer's name) relating to the website could be provided along with the web page perpetually, i.e., each new instance that the camera module is pointed at or until a setting is changed or deleted in the memory of the embed device 143. (or embed device 145) (See discussion below). (Step 1807)

Since the tagging control unit 135 also detected that the image of the camcorder includes text data (i.e., OCR data) such as the text of a manufacturer's name of the camcorder, the tagging control unit 135 may invoke the OCR algorithm 119 to perform OCR searching on the camcorder as well. In this regard, the tagging control unit 135 may determine that information relating to the detected text (OCR data) will be included in the visual search results and instructs embed device 145 to request that the visual search results include or embed information relating to the text data, in this example the manufacturer name of the camcorder in the visual search results. The embed device 144 receives this instruction and sends a request to the visual search server 54 for data associated with a visual tag of the camcorder such as web page (i.e., a candidate) relating to the camcorder having the information relating to the detected text (e.g., manufacturer name) embedded therein. The visual search server 54 determines if there is any data matching or associated with a visual tag (stored in a memory, such as POI database 74) such as a web page and provides this web page with the name of the manufacturer of the camcorder to the embed device 145 of search module 128 for display on display 28. In this regard, the embed device 145 is capable of instructing the display 28 to show the web page embedded with the name of the camcorder's manufacturer in the web page and its associated meta-information.

The embed device 145 is capable of saving information relating to the barcode (i.e., code-based tag data) in its memory (not shown). As such, whenever the user subsequently points the camera module at the camcorder, the manufacture's name of the camcorder can be included in the web page provided by the visual search 54 to the search module 128 for display on display 28. The price information relating to the website could be provided along with the web page perpetually, i.e., each new instance in which the camera module is pointed at, or until a setting is changed or deleted in the memory of the embed device 145.

Moreover, the tagging control unit 135 may detect additional text data (OCR data) in the image of the camcorder. In this regard, the tagging control unit 135 may utilize the OCR search results generated by the OCR algorithm 119 to recognize that the text data corresponds to a part/serial number of the camcorder, for example. The tagging control unit 135 may determine that information relating to the detected text (e.g., part number/serial number) should be included in the visual search results of the camcorder and instructs embed device 147 to request that the visual search results include or embed information relating to the text data, in this example the part/serial number of the camcorder in the visual search results. The embed device 147 receives this instruction and sends a request to the visual search server 54 for data associated with a visual tag of the camcorder such as web page (i.e., a candidate) relating to the camcorder having the information relating to the detected text (e.g., part number/serial number of the camcorder) embedded therein. The visual search server 54 determines if there is any data matching or associated with a visual tag (stored in a memory, such as POI database 74) of the camcorder such as a web page and provides this web page with the part/serial number of the camcorder to the search module 128 for display on display 28. In this regard, the search module 128 is capable of instructing the display 28 to show the web page with the part/serial number of the camcorder.

The tag(s) (e.g., text data or OCR data and code-based tags, e.g., barcodes) identified in the visual search results (e.g., the image of the camcorder), such as for example, the part/serial number of the camcorder provided to embed device 147 can be dynamically replaced or updated in real-time. For instance, if the user of the mobile terminal points the camera module at the camcorder on a subsequent occasion, (e.g., at a later date) when the part/serial number of the camcorder has changed, the embed device 147 will request the visual search server 54 to provide it with data associated with the new part/serial number of the camcorder, and when received by the embed device 147 of the search module 128, the new part/serial number is provided to display 28 which shows the new part/serial number embedded in the visual search results (i.e., the web page in the above example) and its associated meta-information.

The embed device 147 is capable of dynamically replacing or updating a tag such as an OCR tag or a code-based tag in real-time because the embed device 147 does not save and retrieve the tag initially detected when the OCR/code-based algorithm 119 is executed by the tagging control unit 135 after the tagging control unit 147 identifies text and code-based data in the visual search results (e.g., the image of the camcorder). (Step 1808) Instead, the visual search server is accessed, by the embed device 147, for new and/or updated information associated with the tag when the camera module is subsequently point at or captures an image of the camcorder.

In an alternative exemplary embodiment, the code/string look-up and translation unit 141 may be accessed by the tagging control unit 135 and utilized to modify, replace and/or translate OCR data (e.g., text data) and code-based data with a corresponding string of data (e.g., text string) stored in the code/string look-up and translation unit 141. For instance, in the above example, if the tagging control unit 135 detected text (in the image of the camcorder) of the manufacturer's name in a non-English language (e.g., text in Spanish), (i.e., the media content) the tagging control unit 135 is capable of executing the OCR/code-based algorithm 119 and retrieving data from the code/string look-up and translation unit 141 to translate the non-English language (e.g., Spanish) text of the manufacturer's name into the English form of the manufacturer's name. In this regard, the code/string look-up and translation unit 141 is capable replacing the text string in the non-English language (or any other text string identified by execution of the OCR/code-based algorithm) with the text string of the English version counterpart. Additionally, if the tagging control unit 135 detected a barcode (as in the above example) in the image of the camcorder, the tagging control unit 135 is capable of executing the OCR/code-based algorithm 119 and retrieving data from the code/string look-up and translation unit 141, which may replace the barcode data with one or more other strings stored in the code/string look-up and translation unit 141 such as, for example, the manufacturer of the camcorder (e.g. SONY™). The data (e.g., text strings) stored in the code/string look-up and translation unit 141 may be linked to, or associated with, OCR data and code-based data and this linkage or association may serve as a trigger for the tagging control unit 135 to modify, replace or translate data identified as a result of execution of the OCR/code-based algorithm 141.

It should be pointed out that the replacement strings stored in the code/string look-up and translation unit 141 could relate to translation of a recognized word (identified as a result of execution of the OCR/code-based algorithm) into another language (as noted above) and/or content looked-up based on a recognized word (identified as a result of execution of the OCR/code-based algorithm) and/or any other related information. For example, data relating to verb conjugations, grammar, definitions, thesaurus content, encyclopedia content, and the like may be stored in the code/string look-up and translation unit 141 and may serve as a string(s) to replace identified OCR data and/or code-based data. The one or more strings could also include but are not limited to the product name, product information, brand, make/model, manufacturer and/or any other associated attribute that may be identified by the code/string look-up translation unit 141, based on identification of OCR data and/or code-based data (e.g., barcode).

Using the search module 128, a user of the mobile terminal 10 may also create one or more tags such as, for e.g., code-based tags, OCR tags and visual tags that are linked to physical objects. For instance, the user may point the camera module at or capture an image (i.e., media content) of an object such as for example a book. The image of the book may be provided to the tagging control unit 135, via media content input 67. Using the keypad 30, the user of the mobile terminal 10 may type meta-information relating to the book such as price information, title, author's name, web pages in which the book may be purchased or any other suitable meta-information and link or associate (i.e., tag) this information to a OCR search, for example (or alternatively a code-based search, or a visual search) which is provided to the tagging control unit 135. The tagging control unit 135 may store this information on behalf of the user (for example in a user profile) or transfer this information to the visual search server 54 and/or the visual search database 51 (See FIG. 4) via input/output line 147. By transferring this tag information to the visual search server 54 and the visual search database 51 one or more users of the mobile terminal may be provided with information associated with the tag, when the camera module is pointed at or captures an image of associated media content, i.e., the book for example.

As such, if the tagging control unit 135 subsequently receives media content and performs an OCR search (or a code-based search or a visual search) by executing OCR/code-based algorithm 119 (or visual search algorithm 121), and determines that data associated with the book are within the OCR search results (or code-based search results or visual search results), the tagging control unit 135 may provide the display 28 with a list of candidates (e.g., name of the book, web page where the book can be purchased (e.g., a web site of BORDERS™), price information or any other suitable information) to be shown. Alternatively, the user of the mobile terminal 10 and/or users of other mobile terminals 10 may receive the candidates (via input/output line 147) from either the visual search server 54 and/or the visual search database 51 when the media content (i.e., the book) is matched with associated data stored at the visual search server 54 and/or the visual search database 51.

Additionally or alternatively, it should be pointed out that a user of the mobile terminal may utilize the OCR algorithm 119 (and/or the visual search algorithm 121) to generate OCR tags. For instance, the user of the mobile terminal may point his/her camera module at an object or capture an image of the object (e.g. a book) which is provided to the tagging control unit 135 via media content input 67. Recognizing that the image of the object (i.e., the book) has text data on its cover, the tagging control unit 135 may execute the OCR algorithm 119 and the tagging control unit 135 may label (i.e., tag) the book according to its title, which is identified in the text data on the book's cover. (In addition, the tagging control unit 135 may tag the detected text on the book's cover to serve as keywords which may be used to search content online via the Web browser of the mobile terminal 10.) The tagging control unit 135 may store this data (i.e., title of the book) on behalf of the user or transfer this information to the visual search server 54 and/or the visual search database 51 so that the server 54 and/or the database 51 may provide this data (i.e., title of the book) to the users of one or more mobile terminals 10, when the camera modules 36 of the one or more mobile terminals are pointed at or captures an image of the book. This saves the users of the mobile terminals time and energy required to input meta-information manually by using a keypad 30 or the like in order to generate tags. For instance, when the user points the camera module at a product and there is a code-based tag on the product that already contains information relating to the product, this information can also be used to generate tags without requiring the user to manually input data.

The user of the mobile terminal 10 could generate additional tags when the visual search algorithm 121 is executed. For instance, if the camera module 36 is pointed at an object such as, for example, a box of cereal in a store, information relating to this object may be provided to the tagging control unit 135 via media content input 67. The tagging control unit 135 may execute the visual search algorithm 121 so that the search module 128 performs visual searching on the box of cereal. The visual search algorithm may generate visual results such as an image or video clip for example of the cereal box and included in this image or video clip there may be other data such as, for example, price information, a URL on the cereal box product name (e.g., Cheerios™), manufacturer's name, etc. which is provided the tagging control unit. This data, e.g., price information in the visual search results may be tagged or linked to an image or video clip of the cereal box which may be stored in the tagging control unit on behalf of the user such that when the user of the mobile terminal subsequently points his camera module at or captures media content (an image/video clip) of the cereal box, the display 28 is provided with the information (e.g., price information, a URL, etc.) Additionally, this information may be transferred to visual search server 54 and/or visual search database 51, which may provide users of one or more mobile terminals 10 with the information when the users point the camera module at the cereal box and/or capture media content (an image/video clip) of the cereal box. Again this saves the users of the mobile terminals time and energy required to input meta-information manually by using a keypad 30 or the like in order to create tags.

As noted above, the tags generated by the tagging control unit 135 can be used when the user of the mobile terminal 10 retrieves content from visual objects. Additionally, in view of the foregoing, it should be pointed out that by using the search module 28, the user may obtain embedded code-based tags from visual objects, obtain OCR content added to a visual object, obtain content based on location and keywords (for e.g., from OCR data), and eliminate a number of choices by using keywords-based filtering. For example, when searching information related to a book, the input from an OCR search may contain information such as author name and book title which can be used as keywords to filter out irrelevant information.

The exemplary embodiments of the present invention facilitate leveraging of OCR searching, code-based searching and mobile visual searching in a unified and integrated manner which provides users of mobile devices a better user experience.

It should be understood that each block or step of the flowcharts, shown in FIGS. 6, 8, 10, 12, 14, 16 and 18, and combination of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus (e.g., hardware) means for implementing the functions implemented specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the functions specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving media content and meta-information;
executing a first search algorithm among a plurality of search algorithms and detecting a first type of one or more tags associated with the media content;
determining, via a processor, whether a second and a third type of one or more tags are associated with the media content;
executing a second search algorithm among the plurality of search algorithms and detecting data associated with the second and the third type of one or more tags;
receiving one or more candidates; and
inserting respective ones of the one or more candidates, comprising data corresponding to the second and third type of one or more tags, into a respective one of the one or more candidates corresponding to the first type of one or more tags, wherein the first, second and third types are different.

2. The method of claim 1, wherein the first search algorithm corresponds to a visual search algorithm, the second algorithm corresponds to an optical character recognition search algorithm and a code-based algorithm and wherein the first, second and third types of the one or more tags comprises visual tags, optical character recognition tags and code-based tags, respectively.

3. The method of claim 1, wherein the media content comprises one or more objects in a real-world.

4. The method of claim 1, further comprising:
determining a location of a device capturing an image of the media content or a location of the media content.

5. The method of claim 4, wherein executing the first search algorithm further comprises executing the first search algorithm based in part on the location of the device or the location of the media content.

6. The method of claim 1, wherein the media content comprises at least one of an image, an item of video data, a graphical animation, a digital photograph, or an item of audio data.

7. The method of claim 1, wherein the meta-information comprises one or more rules which define criteria for selecting the first search algorithm among the plurality of search algorithms.

8. An apparatus comprising:
at least one processor; and
at least one memory including computer program code, the at least one memory and the computer program code configured to, with the at least one processor, cause the apparatus to perform at least the following:
receive media content and meta-information;
execute a first search algorithm among a plurality of search algorithms and detect a first type of one or more tags associated with the media content;
determine whether a second and a third type of one or more tags are associated with the media content;
execute a second search algorithm among the plurality of search algorithms and detect data associated with the second and the third type of one or more tags;
receive one or more candidates; and
insert respective ones of the one or more candidates comprising data corresponding to the second and third type of one or more tags into a respective one of the one or more candidates corresponding to the first type of one or more tags, wherein the first, second and third types are different.

9. The apparatus of claim 8, wherein the first search algorithm corresponds to a visual search algorithm, the second algorithm corresponds to an optical character recognition search algorithm and a code-based algorithm and wherein the first, second and third types of the one or more tags comprises visual tags, optical character recognition tags and code-based tags, respectively.

10. The apparatus of claim 8, wherein the media content comprises one or more objects in a real-world.

11. The apparatus of claim 8, wherein the at least one memory and the computer program code are further configured to, with the processor, cause the apparatus to:
determine a location of the apparatus capturing an image of the media content or a location of the media content.

12. The apparatus of claim 11, wherein the at least one memory and the computer program code are further configured to, with the processor, cause the apparatus to:
execute the first search algorithm based in part on the location of the device or the location of the media content.

13. The apparatus of claim 8, wherein the media content comprises at least one of an image, an item of video data, a graphical animation, a digital photograph, or an item of audio data.

14. The apparatus of claim 8, wherein the meta-information comprises one or more rules which define criteria for selecting the first search algorithm among the plurality of search algorithms.

16. A computer program product comprising at least one non-transitory tangible computer-readable storage medium having computer-readable program code portions stored therein, the computer-readable program code portions comprising:
program code instructions configured to facilitate receipt of media content and meta-information;
program code instructions configured to facilitate execution of a first search algorithm among a plurality of search algorithms and detect a first type of one or more tags associated with the media content;
program code instructions configured to determine whether a second and a third type of one or more tags are associated with the media content;
program code instructions configured to facilitate execution of a second search algorithm among the plurality of search algorithms and detect data associated with the second and the third type of one or more tags;
program code instructions configured to facilitate receipt of one or more candidates; and
program code instructions configured to insert respective ones of the one or more candidates comprising data corresponding to the second and third type of one or more tags into a respective one of the one or more candidates corresponding to the first type of one or more tags,
wherein the first, second and third types are different.

17. The computer program product of claim 16, wherein the first search algorithm corresponds to a visual search algorithm, the second algorithm corresponds to an optical character recognition search algorithm and a code-based algorithm and wherein the first, second and third types of the one or more tags comprises visual tags, optical character recognition tags and code-based tags, respectively.

18. The computer program product of claim 16, wherein the media content comprises one or more objects in a real-world.

19. The computer program product of claim 16, further comprising:
program code instructions configured to determine a location of a device capturing an image of the media content or a location of the media content.

20. The computer program product of claim 19, wherein facilitate execution of the first search algorithm further comprises executing the first search algorithm based in part on the location of the device or the location of the media content.
